(19) United States
(12) Patent Application Publication
(10) Pub. No.: US 2026/0278843 A1
(43) Pub. Date: Sep. 17, 2026

(54) LOOKAHEAD SEGMENTATION AND COMPRESSION OF SENSOR DATA FOR AUTOMOTIVE PERCEPTION

(71) Applicant: QUALCOMM Incorporated, San Diego, CA (US)

(72) Inventors: Mustafa Keskin, San Diego, CA (US); Jamie Menjay Lin, San Diego, CA (US); Jonathan Petit, Wenham, MA (US)

(21) Appl. No.: 19/076,474

(22) Filed: Mar. 11, 2025

(51) Int. Cl. G06T 9/00; G01S 17/931; G06T 7/11; G06V 10/25; G06V 10/40; G06V 20/56

(52) U.S. Cl. CPC G06T 9/00; G01S 17/931; G06T 7/11; G06V 10/25; G06V 10/40; G06V 20/56; G06T 2207/10028

(57) ABSTRACT

A computing system of a device may include processing circuitry that determines, based on the sensor data generated by one or more sensors of the device that captures an environment around the device, attributes of external objects in the environment. The processing circuitry may determine priority levels of the external objects based on the attributes of the external objects, wherein the priority levels of the external objects are indicative of a likelihood of the external objects interfering with the device. The processing circuitry may segment the sensor data into a plurality of portions of the sensor data associated with regions of the environment based on the priority levels of the external objects in the regions of the environment. The processing circuitry may adaptively format the plurality of portions of the sensor data based on the priority levels of the external objects in the regions of the environment.

### TECHNICAL FIELD

This disclosure relates to sensor systems, including sensor systems for advanced driver-assistance systems (ADAS).

### BACKGROUND

An autonomous or semi-autonomous driving vehicle is a vehicle that is configured to sense the environment around the vehicle, such as the existence and location of other objects, and operating without or limited human control. An autonomous driving vehicle may include sensor systems such as cameras, a radar system, a Light Detection and Ranging (LiDAR) system or other sensor system for sensing objects around the autonomous driving vehicle. In some examples, such an autonomous driving vehicle may be referred to as an ego vehicle. A vehicle having an advanced driver-assistance systems (ADAS) is a vehicle that includes systems which may assist a driver in operating the vehicle, such as parking or driving the vehicle.

### SUMMARY

The present disclosure generally relates to techniques and devices for prioritizing features detected by the sensors of a vehicle in an environment around the vehicle and formatting the sensor data that senses the environment based on the prioritization of the features. As the vehicle travels (e.g., is driven), an ADAS of the vehicle may use sensor data generated by the vehicle's sensors to collect information about the vehicle's surroundings and to make decisions.

Other objects around the vehicle may potentially occlude other objects and/or portions of the road from the field of view of the vehicle's sensors. Such potentially occlusions may create challenges for the vehicle's ADAS to correctly perform perception, prediction, and decision-making tasks for the purposes of autonomous driving or assisting the driver of the vehicle, which may compromise the safety of the vehicle.

An ADAS that is able to determine potential causes for occlusion of objects and/or portions of the road from the field of view of the vehicle's sensors may be able to perform perception, prediction, and/or decision-making tasks to decrease the likelihood of such occlusions from occurring. For example, the ADAS system may proactively change the speed at which the vehicle is traveling, switch the vehicle to a different lane, change the route being driven, and the like to reduce the likelihood of certain objects and/or portions or the road being occluded from the field of view of the vehicle's sensors.

In accordance with aspects of this disclosure, a computing system of a vehicle may determine priority levels of features detected by the sensors of a vehicle, such as other vehicles, portions of the road, and/or other objects, in the environment around the vehicle. The computing system may determine, for a feature, a priority level based on factors such as the likelihood of the feature potentially occluding a portion of the environment from view of the vehicle. The computing system may assign a high priority level to a feature that is highly likely to potentially occlude a portion of the environment from view of the vehicle, and may assign a low priority to a feature that is highly unlikely to potentially occlude a portion of the environment from view of the vehicle.

The computing system may segment the sensor data that senses the environment based on the priority levels of the identified features. The vehicle may determine a plurality of regions of interest in the environment, where each region of interest includes a corresponding feature, and each region may be associated with the priority level of the corresponding feature. The computing system may adaptively adjust the compression levels of sensor data for the regions of interest based on the prioritization of the corresponding features in the regions of interest. That is, the computing system may apply a relatively small amount of compression to compress sensor data of regions having a relatively high priority, and may apply a relatively large amount of compression to compress sensor data of regions having a relatively low priority.

By adaptively adjust the compression levels of sensor data for the regions of the environment based on the priority levels of the regions, the computing system may better preserve the details of features that are more likely to potentially occlude portions of the environment from the sensors of the vehicle, while still reducing the amount of storage space that may be needed to store sensor data for other regions in the environment. Improving the preservation of the details of such important features may enable the ADAS to use the preserved features to better determine whether such features will potentially cause occlusion of objects and/or portions of the road from the field of view of the vehicle's sensors, and may improve the ADAS's performance of perception, prediction, and/or decision-making tasks, thereby improving the safety of the vehicle.

In some aspects, the techniques described herein relate to a computing system of a device for processing sensor data, including: a memory; and processing circuitry in communication with the memory, wherein the processing circuitry is configured to: determine, based on sensor data generated by one or more sensors of a device that captures an environment around the device, at least one respective attribute of each external object among a plurality of external objects in the environment; determine priority levels of the plurality of external objects based on the at least one respective attribute of each external object, wherein the priority levels of the plurality of external objects are indicative of respective likelihoods of the plurality of external objects interfering with the device; segment the sensor data into a plurality of portions of the sensor data associated with regions of the environment based on the priority levels of the plurality of external objects in the regions of the environment; and format the plurality of portions of the sensor data based on the priority levels of the plurality of external objects in the regions of the environment.

In some aspects, the techniques described herein relate to a method including: determining, based on sensor data generated by one or more sensors of a device that captures an environment around the device, at least one respective attribute of each external object among a plurality of external objects in the environment; determining priority levels of the plurality of external objects based on the at least one respective attribute of each external object, wherein the priority levels of the plurality of external objects are indicative of respective likelihoods of the plurality of external objects interfering with the device; segmenting the sensor data into a plurality of portions of the sensor data associated with regions of the environment based on the priority levels of the plurality of external objects in the regions of the environment; and formatting the plurality of portions of the sensor data based on the priority levels of the plurality of external objects in the regions of the environment.

In some aspects, the techniques described herein relate to a computer-readable medium storing instructions that, when applied by processing circuitry, causes the processing circuitry to: determine, based on sensor data generated by one or more sensors of a device that captures an environment around the device, at least one respective attribute of each external object among a plurality of external objects in the environment; determine priority levels of the plurality of external objects based on the at least one respective attribute of each external object, wherein the priority levels of the plurality of external objects are indicative of respective likelihoods of the plurality of external objects interfering with the device; segment the sensor data into a plurality of portions of the sensor data associated with regions of the environment based on the priority levels of the plurality of external objects in the regions of the environment; and format the plurality of portions of the sensor data based on the priority levels of the plurality of external objects in the regions of the environment.

In some aspects, the techniques described herein relate to an apparatus including: means for determining, based on sensor data generated by one or more sensors of a device that captures an environment around the device, at least one respective attribute of each external object among a plurality of external objects in the environment; means for determining priority levels of the plurality of external objects based on the at least one respective attribute of each external object, wherein the priority levels of the plurality of external objects are indicative of respective likelihoods of the plurality of external objects interfering with the device; means for segmenting the sensor data into a plurality of portions of the sensor data associated with regions of the environment based on the priority levels of the plurality of external objects in the regions of the environment; and means for formatting the plurality of portions of the sensor data based on the priority levels of the plurality of external objects in the regions of the environment.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a diagram of an example vehicle, in accordance with the techniques of this disclosure.

FIG. 2 is a block diagram illustrating an example computing system, in accordance with the techniques of this disclosure.

FIGS. 3A-3B illustrate an example environment, captured by sensor data, in which a vehicle may operate, in accordance with one to more techniques of this disclosure.

FIG. 4 is a block diagram illustrating an example encoder-decoder architecture for compressing and decompressing segmented sensor data, in accordance with one or more techniques of this disclosure.

FIG. 5 is a block diagram illustrating an example segmentation unit and an example advanced driver assistance system (ADAS) for segmenting and compressing sensor data, in accordance with one or more techniques of this disclosure.

FIG. 6 is a block diagram illustrating an example segmentation unit that broadcasts segmented sensor data to nearby vehicles, in accordance with one or more techniques of this disclosure.

FIG. 7 is a flowchart showing an example method for segmenting and compressing sensor data, according to the techniques of this disclosure.

FIG. 8 is a flowchart showing an example method of operation according to the techniques of this disclosure.

### DETAILED DESCRIPTION

The present disclosure generally relates to techniques and devices for prioritizing features detected by the sensors of a vehicle in an environment around the vehicle and formatting the sensor data that senses the environment based on the prioritization of the features. As the vehicle travels (e.g., is driven), an ADAS of the vehicle may use sensor data generated by the vehicle's sensors to collect information about the vehicle's surroundings and to perform perception, prediction, and/or decision-making tasks.

Other objects around the vehicle, such as other cars, trucks, and the like, environmental elements such as bridges, light posts, the curvature and/or elevation of the road, and the like, may potentially occlude other objects and/or portions of the road from the field of view of the vehicle's sensors. Such potentially occlusions may create challenges for the vehicle's ADAS to correctly perform perception, prediction, and decision-making tasks for the purposes of autonomous driving or assisting the driver of the vehicle, which may compromise the safety of the vehicle.

An ADAS that is able to determine potential causes for occlusion of objects and/or portions of the road from the field of view of the vehicle's sensors may be able to perform perception, prediction, and/or decision-making tasks to decrease the likelihood of such occlusions from occurring. For example, the ADAS system may proactively change the speed at which the vehicle is traveling, switch the vehicle to a different lane, change the route being driven, and the like to reduce the likelihood of certain objects and/or portions or the road being occluded from the field of view of the vehicle's sensors.

Vehicles may include sensors, such as cameras, Light Detection and Ranging (LiDAR) systems, radar systems, and the like, to sense the environment surrounding the vehicle. The sensors of a vehicle may generate sensor data, such as camera images, point clouds, and the like, comprehensive view of a vehicle's surroundings, which enables the ADAS to better perform perception, prediction, and decision-making tasks for the purposes of autonomous driving or assisting the driver of the vehicle.

The large amount of sensor data generated by the sensors may take up a large amount of space in memory the limited amount of memory that may be on-board vehicle computing systems. Further, in potential applications where vehicles may communicate with other vehicles to send and receive sensor data, in order to collect additional information about the vehicle's surroundings, it may be impracticable to send and receive a large amount of sensor data via wireless communication channels given challenges such as limited throughput, noise in the communication channels, and the like.

Vehicle computing systems may compress the sensor data generated by the sensors in an attempt to reduce the amount of space taken by the sensor data in memory and/or to reduce the amount of data that are wirelessly sent and received by vehicles. However, compressing sensor data may involve choosing a level of compression that balances reducing in data size against adequately preserving the details of features in the environment surrounding the vehicle to allow the ADAS to accurately perform perception, prediction, and decision-making tasks based on the compressed sensor data.

In accordance with aspects of this disclosure, the processing circuitry of a vehicle computing system may determine priority levels of features detected by the sensors of a vehicle, such as other vehicles, portions of the road, and/or other objects, in the environment around the vehicle. The processing circuitry may determine, for a feature, a priority level based on factors such as the likelihood of the feature potentially occluding a portion of the environment from view of the vehicle. The processing circuitry may assign a high priority level to a feature that is highly likely to potentially occlude a portion of the environment from view of the vehicle, and may assign a low priority to a feature that is highly unlikely to potentially occlude a portion of the environment from view of the vehicle.

The processing circuitry may segment the sensor data that senses the environment based on the priority levels of the identified features. The processing circuitry may determine a plurality of regions of interest in the environment, where each region of interest includes a corresponding feature, and each region may be associated with the priority level of the corresponding feature. The processing circuitry may adaptively adjust the compression levels of sensor data for the regions of interest based on the prioritization of the corresponding features in the regions of interest. That is, the processing circuitry may apply a relatively small amount of compression to compress sensor data of regions having a relatively high priority, and may apply a relatively large amount of compression to compress sensor data of regions having a relatively low priority.

By adaptively adjust the compression levels of sensor data for the regions of the environment based on the priority levels of the regions, the processing circuitry may better preserve the details of features that are more likely to potentially occlude portions of the environment from the sensors of the vehicle, while still reducing the size of the sensor data that is to be stored in memory or communicated to other vehicles. Improving the preservation of the details of such important features may enable the ADAS to use the preserved features to better determine whether such features will potentially cause occlusion of objects and/or portions of the road from the field of view of the vehicle's sensors, and may improve the ADAS's performance of perception, prediction, and/or decision-making tasks, thereby improving the safety of the vehicle.

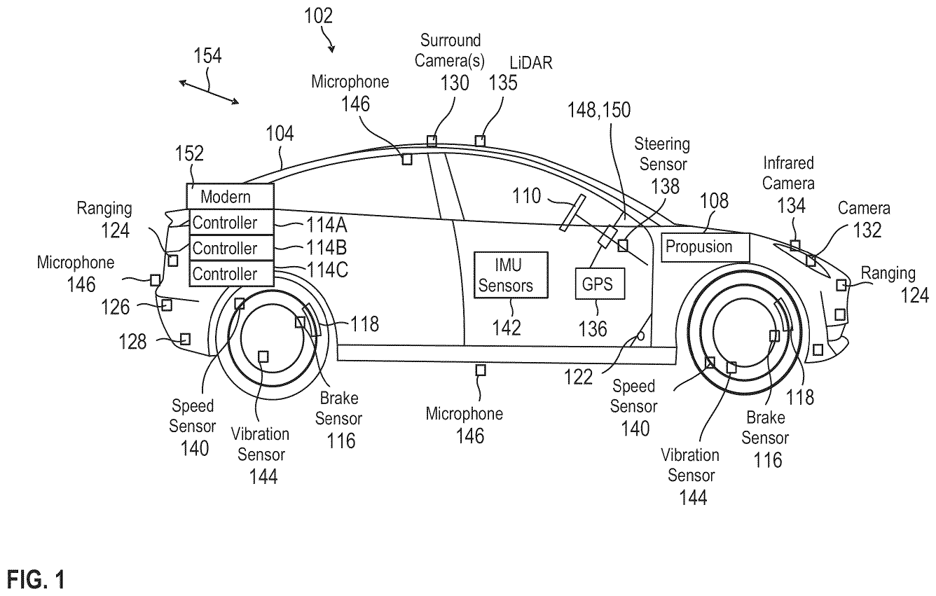

FIG. 1 is a diagram of an example vehicle, in accordance with the techniques of this disclosure. Vehicle 102 in the example shown may comprise any vehicle (such as a car, van or truck) that can accommodate a human driver and/or human passengers. Vehicle 102 may include a vehicle body 104 suspended on a chassis, in this example comprised of four wheels and associated axles.

A propulsion system 108, such as an internal combustion engine, hybrid electric power plant, or even all-electric engine, may be connected to drive some or all the wheels via a drive train, which may include a transmission (not shown). A steering wheel 110 may be used to steer some or all the wheels to direct vehicle 102 along a desired path when the propulsion system 108 is operating and engaged to propel the vehicle 102. Steering wheel 110 or the like may be optional for Level 5 implementations (e.g., for fully autonomous vehicles). One or more controllers 114A-114C (a controller 114) may provide autonomous capabilities in response to signals continuously provided in real-time from an array of sensors, as described more fully below.

Each controller 114 may be one or more onboard computer systems that may be configured to perform deep learning and/or AI functionality and output autonomous operation commands to vehicle 102 and/or assist the human vehicle driver in driving. Each vehicle may have any number of distinct controllers for functional safety and additional features. For example, controller 114A may serve as the primary computer for autonomous driving functions, controller 114B may serve as a secondary computer for functional safety functions, controller 114C may provide AI functionality for in-camera sensors, and controller 114D (not shown in FIG. 1) may provide infotainment functionality and provide additional redundancy for emergency situations. In other examples, all of controllers 114 may be part of a single processing system.

Controller 114 may send command signals to operate vehicle brakes (using brake sensor 116) via one or more braking actuators 118, operate steering mechanism via a steering actuator, and operate propulsion system 108 which also receives an accelerator/throttle actuation signal 122. Actuation may be performed by methods known to persons of ordinary skill in the art, with signals typically sent via the Controller Area Network data interface (“CAN bus”), a network inside modern vehicles used to control brakes, acceleration, steering, windshield wipers, and the like. The CAN bus may be configured to have dozens of nodes, each with its own unique identifier (CAN ID). The bus may be read to find steering wheel angle, ground speed, engine revolutions per minute (RPM), button positions, and other vehicle status indicators. The functional safety level for a CAN bus interface is typically Automotive Safety Integrity Level (ASIL) B. Other protocols may be used for communicating within a vehicle, including FlexRay and Ethernet.

In an aspect, an actuation controller may be provided with dedicated hardware and software, allowing control of throttle, brake, steering, and shifting. The hardware may provide a bridge between the CAN bus of vehicle 102 and the controller 114, forwarding vehicle data to controller 114 including the turn signals, wheel speed, acceleration, pitch, roll, yaw, Global Positioning System (GPS) data, tire pressure, fuel level, sonar, brake torque, and others. Similar actuation controllers may be configured for any make and type of vehicle, including special-purpose patrol and security cars, robo-taxis, long-haul trucks including tractor-trailer configurations, tiller trucks, agricultural vehicles, industrial vehicles, and buses.

One or more processing units, including neural networks, implemented by controllers 114 may provide autonomous driving outputs in response to an array of sensor inputs including, for example: one or more ranging sensors 124 (e.g., sonar, radar, ultrasonic, or other sensors), one or more surround cameras 130 (typically such cameras are located at various places on vehicle body 104 to image areas all around the vehicle body), one or more cameras 132 (in an aspect, at least one such camera may face forward to provide object recognition in the path of vehicle 102), one or more infrared cameras 134, one or more LiDAR (light detection and ranging) sensors 135, GPS unit 136 that provides location coordinates, a steering sensor 138 that detects the steering angle, speed sensors 140 (one for each of the wheels), an inertial sensor or inertial measurement unit (IMU) 142 that monitors movement of vehicle body 104 (this sensor may be, for example, an accelerometer(s) and/or a gyro-sensor(s) and/or a magnetic compass(es)), tire vibration sensors 144, and microphones 146 placed around and inside the vehicle. Other sensors may also be used. Vehicle 102 may also collect data (e.g., including sensor inputs) that is preferably used to help train and refine the neural networks implemented by controllers 114.

Controller 114 may also receive inputs from an instrument cluster 148 and may provide human-perceptible outputs to a human operator via human-machine interface (HMI) display(s) 150, an audible annunciator, a loudspeaker and/or other means. In addition to traditional information such as velocity, time, and other well-known information, HMI display may provide the vehicle occupants with information regarding maps and vehicle's location, the location of other vehicles (including an occupancy grid) and even the controller's identification of objects and status. For example, HMI display 150 may alert the passenger when the controller has identified the presence of another vehicle or other object, water puddle, stop sign, caution sign, or changing traffic light and is taking appropriate action, giving the vehicle occupants peace of mind that the controller is functioning as intended. In an aspect, instrument cluster 148 may include a separate controller/processor configured to perform deep learning and AI functionality.

It should be noted that, compared to other sensors, cameras 130-134 may generate a richer set of features at a fraction of the cost. Thus, vehicle 102 may include a plurality of cameras 130, 132, capturing images around the entire periphery of the vehicle 102. Camera type and lens selection depends on the nature and type of function. Vehicle 102 may have a mix of camera types and lenses to provide coverage around the vehicle 102; in general, narrow lenses do not have a wide field of view but can see farther. Cameras 130-134 on vehicle 102 may support interfaces such as Gigabit Multimedia Serial link (GMSL) and Gigabit Ethernet.

In some examples, cameras 130, 132 may be responsible for capturing high-resolution images and processing them in real time. The output images of such camera-based systems may be used in applications such as object detection, object velocity estimation, depth estimation, and/or pose detection, including the detection and recognition of objects, such as other vehicles, pedestrians, traffic signs, barriers, curbs, and lane markings, etc. Cameras 130, 132 may be particularly good at capturing color and texture information, which is useful for accurate object recognition and classification.

Cameras 130, 132 may generally be any type of camera configured to capture video or image data in the environment around vehicle 102. Cameras 130, 132 may include monocular, time-of-flight (ToF), and/or stereoscopic cameras. In some examples, cameras 130, 132 may be a camera system including more than one camera sensor. Cameras 130, 132 may include a front facing camera (e.g., a front bumper camera, a front windshield camera, and/or a dashcam), a back facing camera (e.g., a backup camera), side facing cameras (e.g., cameras mounted in sideview mirrors), or surround cameras. Cameras 130, 132 may include color cameras or grayscale cameras.

LiDAR sensor 135 may include one or more light emitters (e.g., lasers) and one or more light sensors. LiDAR sensor 135 may, in some cases, be deployed in or about a vehicle. For example, LiDAR sensor 135 may be mounted on a roof of a vehicle, in bumpers of a vehicle, and/or in other locations of a vehicle. LiDAR sensor 135 may be configured to emit light pulses and sense the light pulses reflected off of objects in the environment.

In some examples, the one or more light emitters of LiDAR sensor 135 may emit such pulses in a 360-degree field around the vehicle so as to detect objects within the 360-degree field by detecting reflected pulses using the one or more light sensors. For example, LiDAR sensor 135 may detect objects in front of, behind, or beside vehicle 102. While described herein as including LiDAR sensor 135, it should be understood that vehicle 102 may use another distance or depth sensing system in place of LiDAR sensor 135. The output of LiDAR sensor 135 are called point clouds or point cloud frames.

Ranging sensors 124 may include one or more of radar (radio detection and ranging) sensors, sonar (sound navigation and ranging) sensors, ultrasonic sensors, or other types of sensors. In general, ranging sensors 124 may use different techniques to measure distances and identify objects in the environment of vehicle 102, may be used in making autonomous and semi-autonomous driving decisions, such as adaptive cruise control, parking assistance, and collision avoidance.

A radar sensor uses radio waves to detect objects and determine their speed and distance from the vehicle. A radar sensor operates by emitting a radio signal which reflects off objects and returns to the radar sensor. The time it takes for the radio waves to return is used by controller 114 to calculate the distance to the object. Radar sensors are particularly effective for long-distance detection and can operate in a wide range of weather conditions, including fog, rain, and snow. Radar sensors are commonly used in adaptive cruise control systems to maintain a safe distance from the vehicle ahead.

Sonar sensors use sound waves instead of radio waves. A sonar sensor emits ultrasonic sound waves that bounce off nearby objects and return to the sensor. By measuring the time it takes for the echoes to return, controller 114 can determine the distance to and size of the objects. Sonar sensors are typically used for short-range applications such as parking assistance and blind-spot detection because sound waves have a shorter range and are more susceptible to atmospheric conditions compared to radio waves.

Ultrasonic sensors are a type of sonar sensor used specifically in automobiles for close-range detection tasks. Ultrasonic sensors emit high-frequency sound waves and controller 114 measures the echo received back to detect objects around vehicle 102. Ultrasonic sensors are effective for parking assistance systems, enabling precise maneuvering in tight spaces by alerting drivers to obstacles around the vehicle. Ultrasonic sensors can detect small objects and are useful for low-speed applications, but their utility diminishes at higher speeds or for long-range detection due to the limited range of sound waves.

The vehicle 102 may include modem 152, preferably a system-on-a-chip (SoC) that provides modulation and demodulation functionality and allows the controller 114 to communicate over the wireless network 154. Modem 152 may include a radio frequency (RF) front-end for up-conversion from baseband to RF, and down-conversion from RF to baseband, as is known in the art. Frequency conversion may be achieved either through known direct-conversion processes (direct from baseband to RF and vice-versa) or through super-heterodyne processes, as is known in the art. Alternatively, such RF front-end functionality may be provided by a separate chip. Modem 152 preferably includes wireless functionality substantially compliant with one or more wireless protocols such as, without limitation: third generation (3G) connectivity, fourth generation (4G) connectivity (e.g., 4G Long Term Evolution (LTE)), fifth generation (5G) connectivity (e.g., 5G or New Radio (NR)), Wi-Fi connectivity, Bluetooth connectivity, vehicle-to-everything (V2X), and other wireless data transmission standards. Modem 152 may allow for the download of additional data from a remote network (e.g., the Internet), including high-definition (HD) maps.

Although the techniques of this disclosure are described with respect to implementation in vehicle 102 (including ADAS), in other implementations the techniques may be used in drones, robots, ships, airplanes, helicopters, motorcycles, all-terrain vehicles (ATVs), or other applications involving moving objects.

As will be explained in more detail below, one or more of controllers 114 may be configured to perform segmentation and formatting of sensor data that captures an environment around vehicle 102 during operation of vehicle 102. One or more of controllers 114 may receive sensor data from one or more sensors of vehicle 102. The one or more sensors may include one or more ranging sensors, one or more surround cameras 130, one or more cameras 132, one or more infrared cameras 134, one or more LiDAR sensors 135, and the like. One or more of controllers 114 may determines, based on the sensor data generated by one or more sensors of vehicle 102 that captures an environment around vehicle 102, attributes of external objects, such as external vehicles, in the environment. One or more of controllers 114 may determine priority levels of the external objects based on the attributes of the external objects, where the priority levels of the external objects are indicative of a likelihood of the external objects interfering with the vehicle. One or more of controllers 114 may segment the sensor data into a plurality of portions of the sensor data associated with regions of the environment based on the priority levels of the external objects in the regions of the environment. One or more of controllers 114 may adaptively format the plurality of portions of the sensor data based on the priority levels of the external objects in the regions of the environment, such as by compressing the plurality of portions of the sensor data based on the priority levels of the external objects in the regions of the environment.

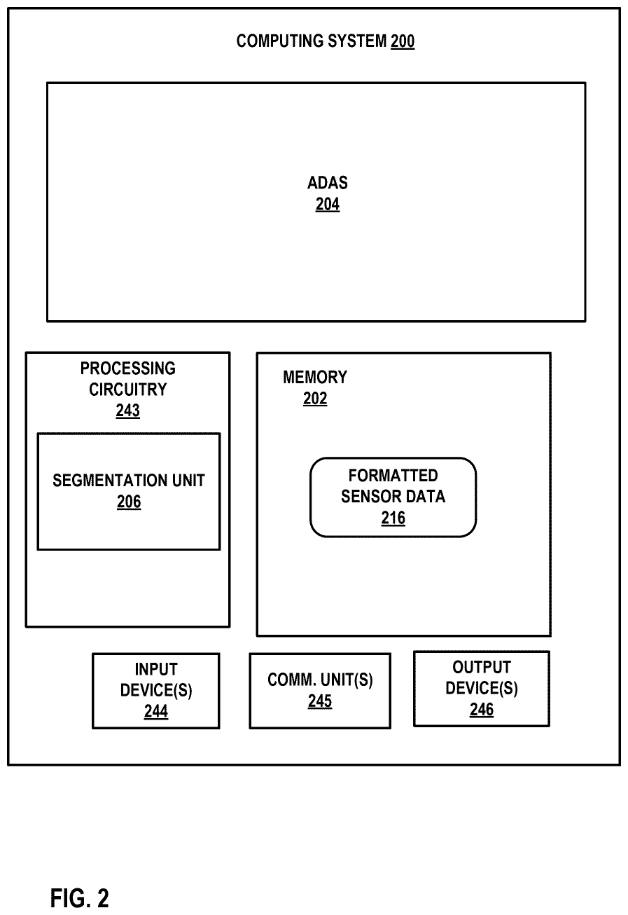

FIG. 2 is a block diagram illustrating an example computing system, in accordance with the techniques of this disclosure. As shown, computing system 200 may be included in vehicle 102 of FIG. 1 and comprises processing circuitry 243 and memory 202 for executing ADAS 204 and segmentation unit 206, which may represent an example instance of any controller 114 described in this disclosure, such as controllers 114A, 114B, and 114C of FIG. 1. While computing system 200 is described as being included in vehicle 102, computing system 200 may, in other examples, perform the techniques of this disclosure while being included in an extended reality device (e.g., an augmented reality device, a virtual reality device, a mixed reality device, etc.), a robotic device, or any other suitable device.

While described with relation to an ADAS, the techniques of this disclosure are not limited to processing sensor data in automotive contexts. Computing system 200 may be applicable for use with any multi-camera and/or multi-sensor system that may employ multiple processing units that include neural networks in order to produce outputs. Examples may include extended reality (XR) systems, virtual reality (VR) systems, spherical or 3-D video, and others.

Computing system 200 may be configured to execute an automated driving system, such as ADAS 204. ADAS 204 may be configured for fully autonomous and/or semi-autonomous driving, such as of vehicle 102.

Computing system 200 may be implemented as any suitable computing system, such as one or more server computers, workstations, laptops, mainframes, appliances, embedded computing systems, cloud computing systems, High-Performance Computing (HPC) systems (i.e., supercomputing systems) and/or other computing systems that may be capable of performing operations and/or functions described in accordance with one or more aspects of the present disclosure. In some examples, computing system 200 may represent a cloud computing system, server farm, and/or server cluster (or portion thereof) that provides services to client devices and other devices or systems. In other examples, computing system 200 may represent or be implemented through one or more virtualized compute instances (e.g., virtual machines, containers, etc.) of a data center, cloud computing system, server farm, and/or server cluster. In an aspect, computing system 200 is disposed in vehicle 102.

In another example, computing system 200 comprises any suitable computing system having one or more computing devices, such as desktop computers, laptop computers, gaming consoles, smart televisions, handheld devices, tablets, mobile telephones, smartphones, etc. In some examples, at least a portion of computing system 200 is distributed across a cloud computing system, a data center, or across a network, such as the Internet, another public or private communications network, for instance, broadband, cellular, Wi-Fi, ZigBee, Bluetooth® (or other personal area network-PAN), Near-Field Communication (NFC), ultrawideband, satellite, enterprise, service provider and/or other types of communication networks, for transmitting data between computing systems, servers, and computing devices.

The techniques described in this disclosure may be implemented, at least in part, in hardware, software, firmware or any combination thereof. For example, various aspects of the described techniques may be implemented within processing circuitry 243 of computing system 200, which may include one or more of a microprocessor, a controller, a digital signal processor (DSP), an application specific integrated circuit (ASIC), a field-programmable gate array (FPGA), or equivalent discrete or integrated logic circuitry, or other types of processing circuitry. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure. Processing circuitry 243 may include one or more central processing units (CPUs), such as single-core or multi-core CPUs, graphics processing units (GPUs), digital signal processor (DSPs), neural processing unit (NPUs), multimedia processing units, and/or the like.

An NPU is a specialized circuit configured for implementing control and arithmetic logic for executing machine learning algorithms, such as algorithms for processing artificial neural networks (ANNs), deep neural networks (DNNs), random forests (RFs), kernel methods, and the like. An NPU may sometimes alternatively be referred to as a neural signal processor (NSP), a tensor processing unit (TPU), a neural network processor (NNP), an intelligence processing unit (IPU), or a vision processing unit (VPU).

Memory 202 may comprise one or more storage devices. One or more components of computing system 200 (e.g., processing circuitry 243, memory 202, etc.) may be interconnected to enable inter-component communications (physically, communicatively, and/or operatively). In some examples, such connectivity may be provided by a system bus, a network connection, an inter-process communication data structure, local area network, wide area network, or any other method for communicating data. Processing circuitry 243 of computing system 200 may implement functionality and/or execute instructions associated with computing system 200. Examples of processing circuitry 243 include microprocessors, application processors, display controllers, auxiliary processors, one or more sensor hubs, and any other hardware configured to function as a processor, a processing unit, or a processing device. Computing system 200 may use processing circuitry 243 to perform operations in accordance with one or more aspects of the present disclosure using software, hardware, firmware, or a mixture of hardware, software, and firmware residing in and/or executing at computing system 200. The one or more storage devices of memory 202 may be distributed among multiple devices.

Memory 202 may store information for processing during operation of computing system 200. In some examples, memory 202 comprises temporary memories, meaning that a primary purpose of the one or more storage devices of memory 202 is not long-term storage. Memory 202 may be configured for short-term storage of information as volatile memory and therefore not retain stored contents if deactivated. Examples of volatile memories include random-access memories (RAM), dynamic random-access memories (DRAM), static random-access memories (SRAM), and other forms of volatile memories known in the art. Memory 202, in some examples, may also include one or more computer-readable storage media. Memory 202 may be configured to store larger amounts of information than volatile memory. Memory 202 may further be configured for long-term storage of information as non-volatile memory space and retain information after activate/off cycles. Examples of non-volatile memories include magnetic hard disks, optical discs, Flash memories, or forms of electrically programmable read only memories (EPROM) or electrically erasable and programmable (EEPROM) read only memories.

Memory 202 may store program instructions and/or data associated with one or more of the modules described in accordance with one or more aspects of this disclosure. For example, memory 202 may store formatted sensor data 216.

One or more input device(s) 244 of computing system 200 may generate, receive, or process input. Such input may include input from a keyboard, pointing device, voice responsive system, video camera, biometric detection/response system, button, sensor, mobile device, control pad, microphone, presence-sensitive screen, network, or any other type of device for detecting input from a human or machine.

One or more output device(s) 246 may generate, transmit, or process output. Examples of output are tactile, audio, visual, and/or video output. Output devices 246 may include a display, sound card, video graphics adapter card, speaker, presence-sensitive screen, one or more universal serial bus (USB) interfaces, video and/or audio output interfaces, or any other type of device capable of generating tactile, audio, video, or other output. Output devices 246 may include a display device, which may function as an output device using technologies including liquid crystal displays (LCD), quantum dot display, dot matrix displays, light emitting diode (LED) displays, organic light-emitting diode (OLED) displays, cathode ray tube (CRT) displays, e-ink, or monochrome, color, or any other type of display capable of generating tactile, audio, and/or visual output. In some examples, computing system 200 may include a presence-sensitive display that may serve as a user interface device that operates both as one or more input devices 244 and one or more output devices 246.

One or more communication units 245 of computing system 200 may communicate with devices external to computing system 200 (or among separate computing devices of computing system 200) by transmitting and/or receiving data, and may operate, in some respects, as both an input device and an output device. In some examples, communication units 245 may communicate with other devices over a network. In other examples, communication units 245 may send and/or receive radio signals on a radio network such as a cellular radio network. Examples of communication units 245 include a network interface card (e.g., such as an Ethernet card), an optical transceiver, a radio frequency transceiver, a GPS receiver, or any other type of device that can send and/or receive information. Other examples of communication units 245 may include Bluetooth®, GPS, 3G, 4G, 5G and Wi-Fi® radios found in mobile devices as well as Universal Serial Bus (USB) controllers and the like.

Computing system 200 may be configured to perform techniques for receiving sensor data from one or more sensors (e.g., one or more ranging sensors, one or more surround cameras 130, one or more cameras 132, one or more infrared cameras 134, and/or one or more LiDAR sensors 135 shown in FIG. 1), formatting the segmented sensor data, or any combination thereof. For example, processing circuitry 243 may include segmentation unit 206. Segmentation unit 206 may be implemented in software, firmware, and/or any combination of hardware described herein. As will be described in more detail below, segmentation unit 206 may be configured to receive sensor data, such as 2D camera images and 3D point cloud frames from one or more sensors of vehicle 102 and to format the received sensor data as formatted sensor data 216 that segmentation unit 206 may store in memory 202 for use by ADAS 204 and/or send to other vehicles via communication units 245.

Segmentation unit 206 may be configured to receive sensor data from one or more sensors of vehicle 102 that captures an environment around vehicle 102 during operation of vehicle 102, such as when vehicle 102 is being driven on a road. The environment around vehicle 102 may include features such as the road lanes, road boundaries, objects (e.g., vehicles), road signs, and the like surrounding the vehicle that are within the field of view of the one or more sensors of vehicle 102.

Segmentation unit 206 may be configured to identify, based on the sensor data, features in the environment. The features in the environment may include one or more external objects, such as other vehicles (e.g., vehicles other than vehicle 102), road signs, and the like. The features in the environment may also include portions of roads in the environment, road conditions of the portions of the road, and the like.

Segmentation unit 206 may be configured to determine attributes of the identified features in the environment. Segmentation unit 206 may determine, for each feature (e.g., each external object) of the identified features, a respective one or more attributes. Example attributes of a feature may include the type of the feature, the location of the feature, and the like. In examples where the identified feature is a vehicle, example attributes of the vehicle may include the type of the vehicle, the speed of the vehicle, the size of the vehicle, whether or not the vehicle is traveling in a pack with other vehicles, the driving style of the vehicle, whether the vehicle is accelerating or decelerating, the stopping distance of the vehicle, the direction and orientation of the vehicle, lane information of the vehicle

Segmentation unit 206 may be configured to determine priority levels of the identified features in the environment based on the determined attributes of the features. That is, segmentation unit 206 may determine, based on the respective one or more attributes for each feature of the identified features, priority levels of the identified features. Segmentation unit 206 may determine a priority level of a feature based on a likelihood of the feature interfering with vehicle 102 in the near future, such as a likelihood of the feature potentially occluding a portion of the environment from the field of view of the sensors of vehicle 102 in the near future, a likelihood of the vehicle colliding with the feature, or a likelihood of the feature potentially causing a hazard scenario for vehicle 102. A higher priority level may denote a higher likelihood of the feature interfering with vehicle 102 in the near future, while a lower priority level may denote a lower likelihood of the feature interfering with vehicle 102 in the near future. In this way, segmentation unit 206 may assign, to each identified feature in the environment, a priority level out of a plurality of priority levels.

Segmentation unit 206 may be configured to segment the sensor data into a plurality of portions of the sensor data associated with corresponding regions of the environment based on the priority levels of the external objects, such as external vehicles, in the regions of the environment. Segmentation unit 206 may determine, in the environment, regions of interest associated with the identified features, where each region of interest in the environment includes at least a portion of the associated feature. For example, segmentation unit 206 may, for an identified feature in the environment, determine a region of interest in the environment that includes at least a portion of the identified feature, and may determine the size and/or position of the region of interest in the environment. Segmentation unit 206 may determine, for each of the regions of interest, a priority level that corresponds to the priority level of the feature. For example, if a vehicle is identified to have a highest priority level out of a plurality of priority levels, segmentation unit 206 may determine that a region of interest that contains the vehicle may also have the highest priority level out of a plurality of priority levels.

Segmentation unit 206 may be configured to adaptively format the plurality of portions of the sensor data based on the priority levels of the vehicles in the regions of the environment. In examples where segmentation unit 206 communicates with other vehicles to send and receive sensor data, segmentation unit 206 may communicate, via communication units 245, with computing systems of other vehicles to negotiate a common data format for transmitting and receiving sensor data. Thus, segmentation unit 206 may format the sensor data according to the common data format to send one or more portions of the sensor data to computing systems of the other vehicles.

In some examples, segmentation unit 206 may output information, such as a notification, indicative of vehicle 102 possibly colliding with one or more of the identified features, for the purposes of collision avoidance. For example, segmentation unit 206 may output, such as for display at a display device of or communicably coupled to vehicle 102, an indication of a region of interest having a highest priority level, such as in the form of a visual indication of one or more identified features in the region of interest having a high probability of colliding with vehicle 102.

In some examples, segmentation unit 206 may store the segmented portions of sensor data as formatted sensor data 216. Segmentation unit 206 may adaptively compress the portions of the sensor data based on the priority levels of the regions of interest of the environment to generate compressed sensor data that segmentation unit 206 may store in memory 202 as formatted sensor data 216.

Segmentation unit 206 may adaptively compress the portions of the sensor data based on compression levels for compressing the plurality of portions of the sensor data that inversely correlate to the priority levels of the regions of interest in the environment. That is, segmentation unit 206 may apply a relatively low amount of compression (or no compression) to sensor data associated with regions of a high priority level, and may apply a relatively high amount of compression to sensor data associated with regions of a low priority level. In this way, segmentation unit 206 may be able to better preserve the details of features that may be more likely to interfere with vehicle 102 in the near future while more heavily compress features that may be less likely to interfere with vehicle 102 in the near future.

For example, segmentation unit 206 may determine that a first region of interest in the environment is associated with a first priority level and that a second region of interest in the environment is associated with a second priority level that is of lower priority than the first priority level. Segmentation unit 206 may determine, based on the first region of interest being associated with the first priority level, a first compression level for compressing the first region of interest. Similarly, segmentation unit 206 may determine, based on the second region of interest being associated with the second priority level, a second compression level for compressing the second region of interest. Because the first priority level associated with the first region of interest is higher than the second priority level associated with the second region of interest, segmentation unit 206 may determine the first compression level for compressing the first region of interest to be a lower amount of compression than the second compression level for compressing the second region of interest. That is, because the first priority level associated with the first region of interest is higher than the second priority level associated with the second region of interest, segmentation unit 206 may more heavily compress the second region of interest compared to the first region of interest.

ADAS 204 may control, based on the formatted sensor data 216 generated by segmentation unit 206, vehicle 102 that includes computing system 200. ADAS 204 may control vehicle 102 to perform perception, prediction, and decision-making tasks for the purposes of autonomous driving or assisting the driver of vehicle 102. In examples where formatted sensor data 216 is compressed sensor data, ADAS 204 may decompress formatted sensor data 216 to generate reconstructed sensor data that ADAS 204 may use to perform perception, prediction, and decision-making tasks for the purposes of autonomous driving or assisting the driver of vehicle 102.

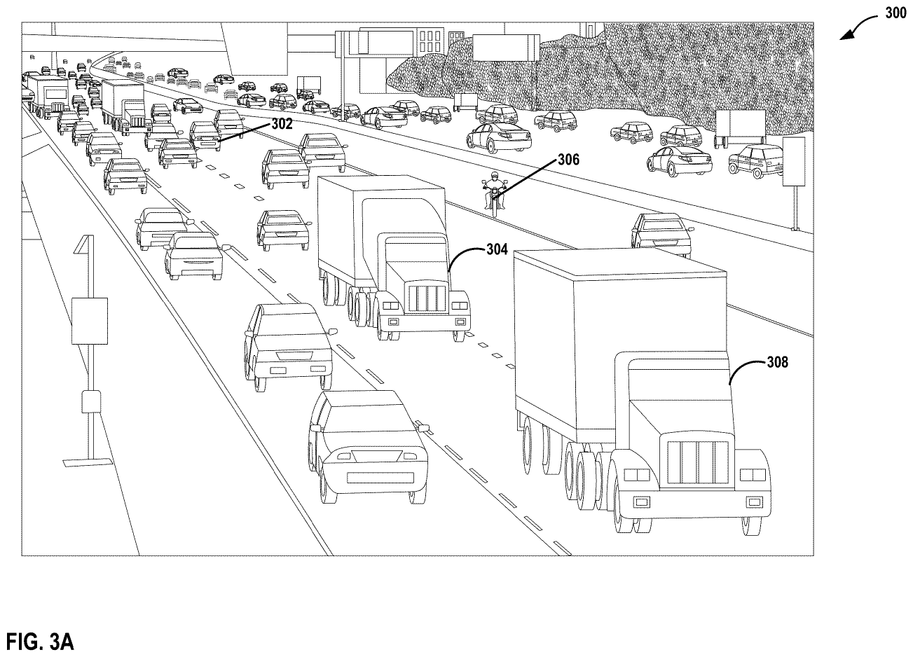

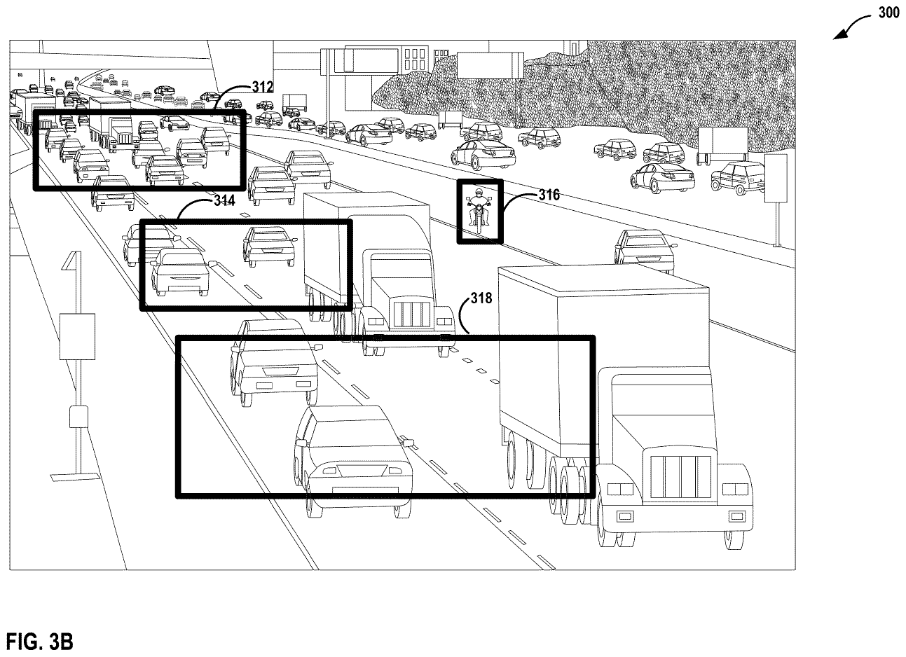

FIGS. 3A-3B illustrate an example environment, captured by sensor data, in which a vehicle may operate, in accordance with one to more techniques of this disclosure. FIGS. 3A-3B is described with respect to vehicle 102 of FIG. 1 and computing system 200 of FIG. 2.

As shown in FIG. 3A, image 300 illustrates an environment around vehicle 302, also referred to herein as ego vehicle 302. Vehicle 302 is an example of vehicle 102 that includes computing system 200 of FIG. 2.

Segmentation unit 206 of computing system 200 may receive sensor data generated by one or more sensors of vehicle 302. The sensor data may capture at least a portion of an environment around vehicle 302, such as the road lanes, road boundaries, objects (e.g., vehicles), road signs, and the like surrounding vehicle 302 that are within the field of view of the one or more sensors of vehicle 302.

Segmentation unit 206 may identify, based on the sensor data, features in the environment. The features in the environment may include one or more external objects, such as vehicles (e.g., cars, trucks, motorcycles, etc.), road signs, and the like. The features in the environment may also include external objects such as portions of roads in the environment, road conditions of the portions of the road, and the like. In the example of FIG. 3A, segmentation unit 206 may identify, as features, vehicle 302, truck 304, motorcycle 306, and truck 308. As vehicle 302 in the example of FIG. 3A is the ego vehicle, truck 304, motorcycle 306, and truck 308 may be referred to as external vehicles, as they are vehicles external to vehicle 302.

Segmentation unit 206 may determine attributes of the identified features in the environment. That is, segmentation unit 206 may determine at least one respective attribute of each feature among the identified features in the environment. For features in the environment identified as objects, segmentation unit 206 may determine, for each object, attributes such as the type of the object, such as whether the object is a vehicle, a road sign, and the like. Segmentation unit 206 may also determine, for each object that is a vehicle, the type of vehicle, attributes such as whether the vehicle is a car, a truck, a van, a sports utility vehicle, a tractor trailer, a bicycle, a motorcycle, and the like. For example, segmentation unit 206 may determine that truck 304 is a tractor trailer, motorcycle 306 is a motorcycle, and truck 308 is a tractor trailer.

Segmentation unit 206 may also determine, for each vehicle, attributes such as the location of the vehicle in the environment (e.g., the proximity of the vehicle to vehicle 302), the speed of the vehicle (e.g., an absolute speed or the speed in relation to the speed of vehicle 302), the size of the vehicle, the speed at which the vehicle is traveling, whether or not the vehicle is traveling in a pack with other vehicles, the driving style of the vehicle, whether the vehicle is accelerating or decelerating, the stopping distance of the vehicle, the direction and orientation of the vehicle, lane information of the vehicle.

For example, segmentation unit 206 may determine that trucks 304 and 308 are large vehicles and that motorcycle 306 is a small vehicle. Segmentation unit 206 may determine that motorcycle 306 does not have any other vehicles in close proximity on the road and is traveling on a lane to the left of vehicle 302, while trucks 304 and 308 are in a single lane proximate to each other and to the right of vehicle 302. Segmentation unit 206 may determine that truck 304, motorcycle 306, and truck 308 are each far away from (i.e., not proximate to) vehicle 302 all traveling in the same direction of vehicle 302. Segmentation unit 206 may also determine additional attributes of truck 304, motorcycle 306, and truck 308, such as the speed at which truck 304, motorcycle 306, and truck 308, whether truck 304, motorcycle 306, and truck 308 are accelerating or decelerating, the stopping distance of truck 304, motorcycle 306, and truck 308, and the like.

Segmentation unit 206 may determine the motion of vehicles (e.g., speed, direction of travel, trajectory, whether the vehicle is accelerating or decelerating, etc.) using techniques such as monitoring changes in optical flow. Optical flow is a technique used in computer vision to estimate motion by changes in the position of objects between consecutive frames in video data. As such, segmentation unit 206 may determine attributes of objects in the environment, such as the motion of such objects, based on sensor data captured by sensors of vehicle 302 over time,

Segmentation unit 206 may, for each of the features identified as portions of the road, determine at least one attributes of portions of the road, such as road conditions (e.g., whether the road is dry, wet, icy, or snowy), whether the road is straight or contains a curve, the angle of the curve (e.g., whether the curve is a gentle curve or a sharp curve), whether the portion of the road is likely to be obstructed from view of the ego vehicle (e.g., by a large truck), etc.

Segmentation unit 206 may determine priority levels of the identified features in the environment based on the at least one respective attributes determined for each of the features. Segmentation unit 206 may determine, for each of the identified features, a respective priority level, out of a plurality of priority levels.

In some examples, segmentation unit 206 may determine a priority level of a feature based on a likelihood of the feature interfering with vehicle 302 in the near future, such as a likelihood of the feature potentially occluding a portion of the environment from the field of view of the sensors of vehicle 302 in the near future or a likelihood of the feature potentially causing a hazard scenario for vehicle 302. Such a hazard scenario may be a situation or a sequence of events in which the operation of vehicle 302 may encounter potential risks or threats to safety, such as an accident (e.g., a car crash).

In some examples, segmentation unit 206 may determine a priority level of a feature based on the proximity of the feature to vehicle 302. Vehicles that are proximate to vehicle 302 may be more likely to occlude the field of view of vehicle 302's sensors and/or to cause a hazard scenario for vehicle 302. In some examples, segmentation unit 206 may assign a highest priority level (referred herein as a first priority level) to features that are within a specified distance (e.g., within a meter) of the ego vehicle, such that segmentation unit 206 determines the features to be proximate to the ego vehicle. Similarly, segmentation unit 206 may assign a relatively lower priority level to features that are not within the specified distance from vehicle 302. In the example of FIG. 3A, segmentation unit 206 may determine vehicle 302 to have the first priority level.

Segmentation unit 206 may assign a second priority level, which is of lower priority than the first priority level, to features that are away from (e.g., not proximate to) vehicle 302 and are ahead of vehicle 302 on the road if the features are getting closers to vehicle 302 over time. These features may be likely to interfere with vehicle 302 in the future, such as occluding the field of view of vehicle 302's sensors and/or causing a hazard scenario for vehicle 302. Such features may be likely to interfere with vehicle 302 in the future may include portions of the road (e.g., in the same lane in which vehicle 302 is currently traveling) that have hazardous conditions, large vehicles (e.g., trucks), vehicles traveling slowly in the same lane in which vehicle 302 is current traveling, and the like. In the example of FIG. 3A, segmentation unit 206 may determine trucks 304 and 308 to have the second priority level.

Segmentation unit 206 may assign a third priority level, which is of lower priority than the second priority level, to features that have a relatively lower probability of interfering with vehicle 302. These features may include vehicles that are identified as not directly interfering with vehicle 302, but are determined to be fast moving vehicles or vehicles determined to be driving dangerously, which may have some likelihood of interfering with vehicle 302 in the future. In the example of FIG. 3A, segmentation unit 206 may determine motorcycle 306 to have the third priority level.

Segmentation unit 206 may assign a fourth priority level, which is of lower priority than the third priority level, to features that are determined to not interfere with vehicle 302, are determined to not be fast moving, and are determined to not be driving dangerously.

Segmentation unit 206 may dynamically update the priority levels of features over time. That is, once segmentation unit 206 has determined the priority levels of features in the environment, segmentation unit 206 may change the priority levels of the features over time as segmentation unit 206 determines updated information (e.g., updated attributes) of the features based on additional sensor data generated by the sensors of vehicle 302. For example, segmentation unit 206 may increase the priority level of a vehicle if segmentation unit 206 determines that the vehicle is getting closer and closer to vehicle 302 over time. In another example, segmentation unit 206 may decrease the priority level of a vehicle if segmentation unit 206 determines that the vehicle is less likely to cause a potential hazard scenario for vehicle 302.

Segmentation unit 206 may segment the sensor data into a plurality of portions of the sensor data based on the determined priority levels of the identified features in the environment. Segmentation unit 206 may segment the environment into regions of interest that correspond to at least a subset the identified features in the environment and/or the priorities assigned to the features. For example, segmentation unit 206 may determine, for each feature of a plurality of identified features in the environment, a corresponding region of interest in the environment that includes at least a portion of the feature.

Segmentation unit 206 may segment the sensor data that corresponds to the regions of interest in the environment into portions of sensor data. In the example of 3D point cloud frames, segmentation unit 206 may identify, for each region of interest, the 3D point cloud belonging to the region of interest, and may segment the 3D point clouds by associating each region of interest with the identified 3D point cloud belonging to the region of interest.

In the example of 2D camera images captured by cameras, segmentation unit 206 may determine regions of interest in an image that correspond to the identified features in the environment and/or the priorities assigned to the features, such as by determining, for each feature of a plurality of identified features in the environment, a corresponding region of interest in the image that includes at least a portion of the feature.

In some examples, segmentation unit 206 may determine the size, position, and/or shape of a region of interest to capture a portion of a vehicle in the region of interest. As shown in FIG. 3B, segmentation unit 206 may determine, in the environment captured in image 300, region 312 that includes at least a portion of vehicle 302, region 314 that includes at least a portion of truck 304, region 316 that includes at least a portion of motorcycle 306, and region 318 that includes at least a portion of truck 308.

Vehicle 302 is an ego vehicle that includes segmentation unit 206. As such, segmentation unit 206 may determine region 312 to have a size and position to include features (e.g., other vehicles or external objects) that are within a specified distance (e.g., within a meter) of vehicle 302, such that segmentation unit 206 determines the feature to be proximate to vehicle 302. The region of interest may include, for example, features in the same lane of vehicle 302 as well as features in the immediate neighboring lanes to vehicle 302.

Segmentation unit 206 may determine that motorcycle 306 is a small vehicle that ahead of, in a different lane from, and far away from vehicle 302. As such, segmentation unit 206 may determine region 314 to include motorcycle 306 and the immediate surroundings of motorcycle 306.

Segmentation unit 206 may determine region 314 that includes at least a portion of truck 304 and region 318 that includes at least a portion of truck 308. Segmentation unit 206 may determine that trucks 304 and 308 are large vehicles traveling in a lane that is to the immediate right of the lane in which vehicle 302 is traveling. As such, trucks 304 and 308 may possibly occlude objects in the lane to the right of trucks 304 and 308. Thus, segmentation unit 206 may determine regions 314 and 318 to each have a size and position to capture trucks 304 and 308, respectively, vehicles on the opposite side of trucks 304 and 308 from vehicle 302 (e.g., in the lane to the right of trucks 304 and 308), and any other vehicles in the vicinity of trucks 304 and 308 that are traveling at similar speeds as and/or tailgating trucks 304 and 308. As can be seen, a region such as region 314 may include objects of different priority levels, such as truck 304 having a second priority level due to its size and position, as well as a vehicle on the opposite side of truck 304 from vehicle 302 having a lower priority level than truck 304.

In some examples, segmentation unit 206 may not segment the environment to determine regions of interest for features that are below a specified priority level. In the example where each feature is associated with one of four priority levels, segmentation unit 206 may determine, for each feature of a plurality of identified features associated with one of the top three priority levels in the environment, a corresponding region of interest in the environment that includes the feature. However, segmentation unit 206 may refrain from determining regions of interest for features in the fourth priority level. Rather, segmentation unit 206 may group the remaining regions of the environment outside of the determined regions of interest as a single region. For example, segmentation unit 206 may combine regions of the captured environment outside of regions 312, 314, 316, and 318 into a single region.

In some examples, segmentation unit 206 may merge two or more regions of interest that are nearby (e.g., within a threshold distance in the environment) and that are associated with the same priority level into a single region of interest. Such a merged region of interest may include the two or more regions of interest as well as regions separating the two or more regions of interest from each other. For example, segmentation unit 206 may merge regions 314 and 318, as well as the areas between regions 314 and 318, into a single region.

In some examples, segmentation unit 206 may determine a region of interest that includes a group of vehicles in close proximity (e.g., each with a specified distance from another vehicle in the group of vehicles) that are traveling at approximately the same or similar speeds (e.g., each traveling at a speed that differs by no more than a threshold speed), separated from other vehicles in the environment by at least a specified distance. Segmentation unit 206 may perform any suitable clustering techniques, such as k-means clustering or determining a gaussian distribution to determine whether a group of vehicles are to be clustered in a region of interest that includes the group of vehicles.

Segmentation unit 206 may associate each region of interest with the priority level of the feature that are included in the region of interest, such as by associating each region of interest with the highest priority level out of the priority levels of the features included in the region of interest, associating each region of interest with the average of the priority levels of the features included in the region of interest, and the like. For example, region 312 includes vehicle 302 having a first priority level (out of four priority levels), and segmentation unit 206 may associate region 312 with the first priority level. In another example, region 316 includes motorcycle 306 having a third priority level, and segmentation unit 206 may associate region 316 with the third priority level. Similarly, regions 314 and 318 include trucks 304 and 308, respectively, each having a second priority level, and segmentation unit 206 may associate each of regions 314 and 318 with the second priority level. Segmentation unit 206 may associate the remaining region of the environment with the lowest priority level, such as the fourth priority level out of four priority levels.

Segmentation unit 206 may compress the sensor data according to the determined priority levels. Segmentation unit 206 may store the compressed sensor data in memory 160 or may transmit the compressed sensor data (e.g., via communication units 245) to other vehicles near vehicle 302. Other components and/or modules of processing system 100, such as the ADAS, may decompress the sensor data to generate reconstructed sensor data capturing the environment around vehicle 302 that the ADAS may use to perform perception, prediction, and decision-making tasks.

Each region of the plurality of regions may be associated with a priority level, and segmentation unit 206 may, for each region, compress sensor data associated with the region based on the priority associated with the region. That is, segmentation unit 206 may determine the amount of compression to apply to sensor data associated a region based on the priority level of the region, and may vary the amount of compression that is applied to regions of different priority levels.

The amount of compression applied to sensor data associated with regions of the environment may be inversely correlated with the priority levels of the regions. That is, segmentation unit 206 may apply a relatively low amount of compression (or no compression) to sensor data associated with regions of a high priority level, and may apply a relatively high amount of compression to sensor data associated with regions of a low priority level. In the example where regions of the environment are each associated with one of four priority levels, where the first priority level is the highest priority level, segmentation unit 206 may not compress regions of the first priority level, may apply a first compression level, such as 20% compression, to regions of the second priority level, apply a second compression level, such as 40% compression, to regions of the third priority level, and apply a highest compression level, such as 60% compression, to regions of the fourth priority level.

In some examples, segmentation unit 206 may apply different amounts of compression to different regions having different priority levels by adjusting the quantization levels (e.g., last significant bit size) of the compressed regions based on the respective priority levels of the regions. In the example where regions are associated with one of four priority levels, with the first priority level being the highest priority level, segmentation unit 206 may use a largest number of bits (e.g., a 16-bit float) to store each pixel value in the sensor data of a region having a first priority level (i.e., the highest priority level), use a second largest number of bits (e.g., an 8-bit float) to store each pixel value in the sensor data of a region having a second priority level, use a third largest number of bits (e.g., an 8-bit integer) to store each pixel value in the sensor data of a region having a third priority level, and use the fewest number of bits (e.g., a four-bit integer) to store each pixel value in the sensor data of a region having a fourth priority level (i.e., the lowest priority level).

In some examples, segmentation unit 206 may apply different amounts of compression to different regions having different priority levels by adjusting the dynamic range of the compressed regions based on the respective priority levels of the regions. That is, segmentation unit 206 may compress a region having a relatively higher priority level to generate a compressed region having a higher dynamic range compared to a compressed region having a relatively lower priority level. For example, segmentation unit 206 may compress sensor data for a region having a highest priority level by allowing for each pixel value of the compressed region to range from 0 to 256, and may compress sensor data for a region having a lowest priority level by allowing for each pixel value of the compressed region to range from 0 to 4. In this way, segmentation unit 206 may reduce computation costs and communication bandwidth that is used for processing and transmission of the compressed sensor data.

In some examples, segmentation unit 206 segmentation unit 206 may apply different amounts of compression to different regions having different priority levels by downsampling the resolutions of the compressed sensor data based on the respective priority levels of the regions associated with the sensor data. In some examples, such downsampling of the resolutions may be symmetrical or asymmetrical. For example, segmentation unit 206 may compress a first region having a highest priority level by downsampling the sensor data for the first region to a first resolution or may keep the original resolution of the sensor data for the first region, and may compress a second region having a lowest priority level by downsampling the sensor data for the region to a second resolution, where the first resolution is greater than the second resolution.

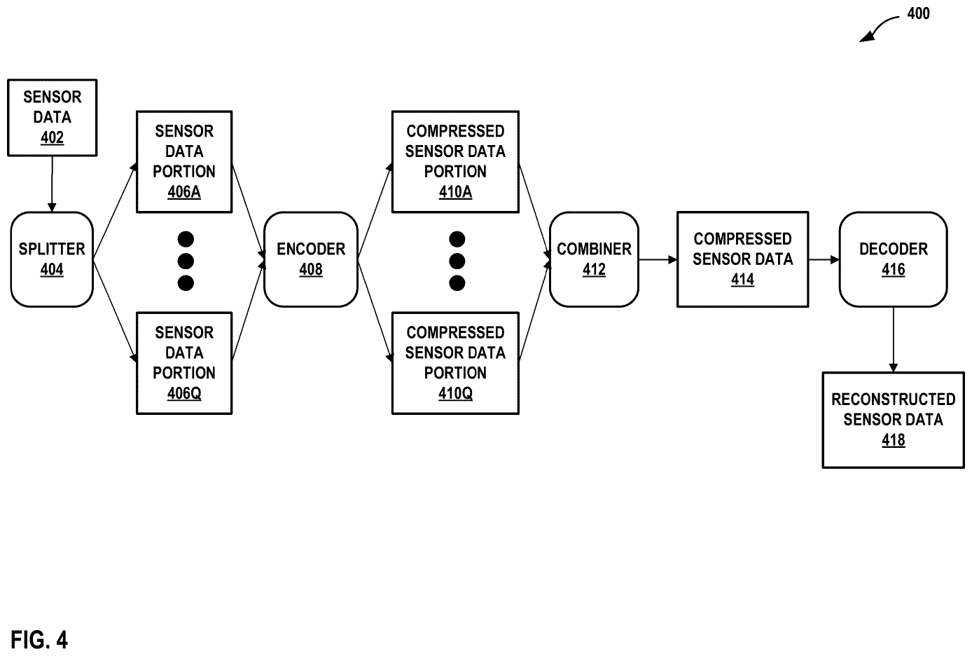

Segmentation unit 206 may use any suitable technique to compress the sensor data. In some examples, as described below with respect to FIG. 4, segmentation unit 206 may use one or more autoencoders to compress the sensor data. In some examples, segmentation unit 206 may use additional neural network-based techniques, such as diffusion-based compression, convolutional neural network-based compression, and the like, as well as compression techniques such as discrete cosine transform, wavelets, or video-based (e.g., Moving Picture Experts Group-based) compression techniques.

In some approaches in which segmentation unit 206 performs compression of sensor data using convolution kernels, such as a two-dimensional convolutional layer (Conv2D) approach, segmentation unit 206 may determine the convolution kernel size for sensor data of a region based on the priority level of the region. Segmentation unit 206 may determine relatively smaller convolution kernel sizes (e.g., a 3×3 kernel) for performing Conv2D compression of sensor data for a region having a relatively lower priority level, and may determine relatively larger convolution kernel sizes (e.g., a 5×5 kernel or a 7×7 kernel) for performing Conv 2D compression of sensor data for a region having a relatively higher priority level. For example, segmentation unit 206 may compress sensor data of a first region having a higher priority level using a 7×7 kernel to perform Conv2D compression of the sensor data for the first region, and may compress sensor data of a second region having a lower priority level using a 3×3 kernel to perform Conv2D compression of the sensor data for the region.

In some approaches in which segmentation unit 206 performs compression of sensor data using neural networks, segmentation unit 206 may control the channel sizes in the activation layers and/or the latent space of the neural networks when compressing sensor data of different regions having different priority levels based on the respective priority levels of the different regions. Segmentation unit 206 may determine relatively larger channel sizes for the activation layers and/or latent space of the neural networks to compress sensor data of regions having relatively higher priority levels, and may determine relatively smaller channel sizes for the activation layers and/or latent space of the neural networks to compress sensor data of regions having relatively smaller priority levels. For example, segmentation unit 206 may compress sensor data of a first region having a higher priority level using a first channel size for the activation layers and/or latent space of the neural networks to compress of the sensor data for the first region, and may compress sensor data of a second region having a lower priority level using a second channel size for the activation layers and/or latent space of the neural networks to compress the sensor data for the region, where the first channel size is greater than the second channel size.

While the techniques of prioritizing, segmenting, and compressing sensor data are described as being performed by segmentation unit 206, the techniques may also be performed by the sensors themselves. Individual sensor systems may individually prioritize, segment, and compress sensor data generated by the sensor systems according to the described techniques, and may store the compressed sensor data to memory 160 and/or transmit the compressed sensor data to the ADAS for performing autonomous driving or assisted driving tasks. In some examples, sensor systems may adaptively adjust how frequently the sensor systems generate sensor data, such as based on the frequency of features detected by the sensor systems. For example, a sensor system may decrease the frequency at which one or more sensors of the sensor system generates sensor data in response to determining that the frequency in which the one or more sensors detects objects is below a specified threshold (e.g., a specified number of objects detected over a specified time period). Similarly, the sensor system may increase the frequency at which one or more sensors of the sensor system generates sensor data in response to determining that the frequency in which the one or more sensors detects objects is above a specified threshold.

In some examples, segmentation unit 206 may adaptively adjust the compression levels of regions associated with different priority levels and/or containing different features over time. Such adjustments may be in response to the ADAS of vehicle 302 requesting that segmentation unit 206 change the amount of compression applied to certain features in the environment and/or the amount of compression applied to regions associated with certain priority levels.

In examples where segmentation unit 206 sends sensor data to other components/modules of processing system 100 or to other vehicles, segmentation unit 206 may adaptively adjust the compression of sensor data based on different factors such as throughput, Reference Signal Received Power (RSRP), accuracy of the results, and the like. Segmentation unit 206 may determine the transmission capacity of the communication channels through which segmentation unit 206 sends the sensor data and may increase or decrease the amount of compression applied to the sensor data based on the he transmission capacity of the communication channels. Similarly, in examples where segmentation unit 206 sends the sensor data via wireless communication channels, segmentation unit 206 may increase or decrease the amount of compression applied to the sensor data based on the RSRP of the wireless communication channels.

In another example, segmentation unit 206 may increase or decrease the amount of compression applied to the sensor data based on how accurately the compressed sensor data represents the environment around vehicle 302. For example, if the ADAS of vehicle 302 determines that it is unable to accurately perform perception, prediction, and decision-making tasks based on the compressed sensor data, segmentation unit 206 may, in response, decrease the amount of compression applied to the sensor data.

In some examples, segmentation unit 206 may adjust the amount of compression applied to the sensor data for sensitive areas in the environment. Sensitive areas in the environment may be regions where precise and detailed sensor data may be required for the ADAS to accurately perform perception, prediction, and decision-making tasks. Examples of such sensitive areas may include road signs, intersections, crowded pedestrian areas, areas with poor visibility, school zones, and the like. Segmentation unit 206 may determine whether the environment around vehicle 302 includes a sensitive area, and may adaptively adjust the compression levels of regions within such a sensitive area, such as by adaptively decreasing the amount of compression applied to regions within an identified sensitive area.

Segmentation unit 206 may also adjust the amount of compression applied to the sensor data based on detecting attack scenarios, such as data tampering, data spoofing, denial of service attacks, and other forms of cyberattack. Segmentation unit 206 may, in response to determining an ongoing cyberattack, adaptively adjust the compression levels applied to the sensor data, such as by adaptively decreasing the amount of compression applied to the sensor data, which may minimize the loss of details in the sensor data.

In some examples, segmentation unit 206 may communicate with other systems and modules of computing system 200, such as modules of an ADAS (e.g., ADAS 204) to receive feedback regarding the prioritization of features and the segmentation and compression of sensor data. Segmentation unit 206 may use such feedback from the ADAS to adjust the prioritization of features, the segmentation of the sensor data, and/or the compression levels of sensor data.

The ADAS may receive (e.g., from segmentation unit 206 or from other modules) information regarding locations of other vehicles on the road with respect to the location of vehicle 302, as well as the compressed sensor data and may determine possible hazard scenarios that may involve other vehicles on the road. Such hazard scenarios may be situations or sequences of events in which the operation of vehicle 302 may encounter potential risks or threats to safety, or in which the other vehicles may occlude portions of the environment from the field of view of vehicle 302's sensors.

The ADAS may communicate the likelihood of the vehicles on the road being involved in potential hazard scenarios to segmentation unit 206, and segmentation unit 206 may adjust the priority levels of the vehicles based on the likelihood of the vehicles being involved in potential hazard scenarios. For example, if the ADAS communicates that a vehicle is highly likely to be involved in a potential hazard scenario, segmentation unit 206 may increase the priority level of the vehicle, which may cause segmentation unit 206 to segment the sensor data to determine a region of interest that includes the vehicle and/or cause segmentation unit 206 to decrease the amount of compression that is applied to a region of interest that includes the vehicle. Similarly, if the ADAS communicates that a vehicle is not likely to be involved in a potential hazard scenario, segmentation unit 206 may decrease the priority level of the vehicle, which may lead to segmentation unit 206 to refrain from determining a region of interest that includes the vehicle and/or cause segmentation unit 206 to increase the amount of compression that is applied to a region of interest that includes the vehicle.

Segmentation unit 206 may also communicate with other vehicles on the road to share (e.g., receive and send) sensor data to and from the other vehicles, such as via communication units 245. Such sharing of sensor data may enable vehicles to share sensor data regarding potentially occluded areas in the environment.

In some examples, vehicles, including vehicle 302, may share bird's eye view (BEV) images of the environment around the vehicles and/or feature maps of features in the environment sensed by the sensors of the vehicles. The vehicles may communicate to determine common regions in the environment that are frequently perceived by multiple different vehicles that are in communications with each other. The vehicles may heavily compress sensor data for those common regions in the environment or may refrain from sending sensor data for those common regions in the environment. In this way, the vehicles may reduce the amount of data that is communicated between the vehicles.

In some examples, segmentation unit 206 may share, with other vehicles, sensor data associated with regions (e.g., blind spots) that the ego vehicle may be occluding from the other vehicles. Segmentation unit 206 may determine, based on sensor data, the locations of other vehicles that are proximate to the ego vehicle. Segmentation unit 206 may determine, based on the locations of other proximate vehicles, regions of the environment that are potentially occluded from the other vehicles by the ego vehicle. Segmentation unit 206 may therefore send, to the other vehicles, sensor data associated with the regions of the environment that are potentially occluded from the other vehicles by the ego vehicle. Such sensor data associated with the regions of the environment sent to the other vehicles may be sensor data for one or more regions of the environment that are compressed according to the techniques of this disclosure.

In some examples, segmentation unit 206 may send and receive sensor data associated with regions having one or more specific priority levels to and from other vehicles, such as sensor data associated with regions having a highest priority level or a second highest priority level out of a plurality of priority levels. Segmentation unit 206 may send and receive such sensor data in uncompressed or compressed form.

Segmentation unit 206 may perform handshaking with other vehicles to negotiate the compression level of the sensor data that are shared between the vehicles and/or to negotiate how to segment sensor data into a plurality of portions. For example, segmentation unit 206 may negotiate with other vehicles to determine how to segment the environment into regions of interest and the amount of compression applied to regions of different priority levels.

Segmentation unit 206 may also communicate with other vehicles to send and receive other useful information, such as in order to build a more complete view of the environment around vehicle 302 and the other vehicles. Because different regions of an environment may be occluded from view of different vehicles, the vehicles may send and receive sensor data that may enable the vehicles to receive sensor data regarding occluded regions of the environment. The vehicles may share sensor data in ways that reduce the amount of data communicated between the vehicles. For example, the vehicles may determine regions of the environment that are common to the vehicles, such as regions of the environment that are not occluded from any of the vehicles, and may refrain from sharing sensor data for those regions of the environment or may heavily compress sensor data for those regions of the environment.

In some examples, each vehicle, including vehicle 302, may generate an occlusion mask, which may be an indication of one or more areas in the environment that are occluded from the vehicle. Such an occlusion mask may, in some examples, be in the form of GPS coordinates, real world coordinates, and the like, denoting the occluded area in the environment. Each vehicle may send its generated occlusion mask to other vehicles and may receive occlusion masks from the other vehicles. Segmentation unit 206 may, in response to receiving an occlusion mask from a requesting vehicle, determine whether sensor d302ata (e.g., 2D camera images and/or 3D point cloud frames) generated by the sensors of processing system 100 include sensor data for the area specified by the received occlusion mask. Segmentation unit 206 may, in response to determining that the sensor data generated by the sensors of processing system 100 include sensor data for the area specified by the received occlusion mask, send the sensor data for the area specified by the received occlusion mask to the requesting vehicle. Similarly, segmentation unit 206 may, in response to sending an occlusion mask to other vehicles, receive, from another vehicle, sensor data for the area specified by the occlusion mask.

As described above, segmentation unit 206 may negotiate the compression levels of the sensor data that are shared between the vehicles. As such, segmentation unit 206 may send and receive such sensor data that are compressed according to the negotiated compression levels. Segmentation unit 206 may also send and receive information regarding how the sensor data sent to other vehicles and received from other vehicles is compressed. For example, segmentation unit 206 may send and receive information such as respective priority levels of regions in the environment associated with the sensor data, the respective compression levels of the sensor data associated with the regions in the environment, the compression technique used to compress the sensor data associated with the regions. In some examples, segmentation unit 206 may share (e.g., send to other vehicles), weights for decoding portions of neural networks that are used to decode (e.g., decompress) the compressed sensor data transmitted by segmentation unit 206 to other vehicles.

Segmentation unit 206 may also communicate with other vehicles to send and receive any other suitable information. In some examples, segmentation unit 206 may transmit, to other vehicles, coordinates (e.g., real world coordinates) of bounding boxes determined by segmentation unit 206 for bounding regions of interest in the environment, for bounding identified features in the environment, and the like. In some examples, segmentation unit 206 may generate (e.g., predict, determine, etc.) semantic labels of the environment, such as dense semantic labels and/or sparse semantic labels, and may transmit such semantic labels to other vehicles. The semantic labels may, for example, label pixels or points in the sensor data with one or more attributes determined or predicted by segmentation unit 206.

In some examples, segmentation unit 206 may transmit a three-dimensional coordinate translation matrix to other vehicles. The three-dimensional coordinate translation matrix may be used by the other vehicles to translate sensor data captured by vehicle 302 to world coordinates or another common frame of reference, or may be used by another vehicle to translate sensor data captured by vehicle 302 to the other vehicle's perspective (e.g., to the other vehicle's local coordinate system).

In some examples, segmentation unit 206 may also communicate with infrastructure devices, which are specialized equipment installed in the road environment. In some examples, such infrastructure devices may communicate with segmentation unit 206 to send indications of dangerous or critical areas of the road. Segmentation unit 206 may, based on the indications of the dangerous or critical areas of the road, adjust the compression levels of sensor data that capture those areas of the road, such as by not compressing or reducing the amount of compression of sensor data that capture those areas of the road.

In some examples, segmentation unit 206 may selectively transmit (e.g., broadcast) sensor data based on regions of the environment that vehicle 302 may be occluding from other adjacent and/or nearby vehicles. Segmentation unit 206 may detect, based on sensor data, vehicles that may be adjacent to and/or nearby vehicle 302, and may determine, based on the adjacent and/or nearby vehicles, regions of the environment that may be occluded by vehicle 302 from the adjacent and/or nearby vehicles, such as regions of the environments that are blind spots caused by the ego vehicle. Segmentation unit 206 may therefore broadcast, to other vehicles, sensor data for the regions of the environments that are blind spots caused by vehicle 302.

FIG. 4 is a block diagram illustrating an example encoder-decoder architecture 400 for compressing and decompressing segmented sensor data, in accordance with one or more techniques of this disclosure. The encoder-decoder architecture shown in FIG. 4 may be implemented by segmentation unit 206 and/or other components of processing system 100, or may be implemented on different processing systems of different vehicles. For example, the encoder of the architecture may be implemented on the processing system of a first vehicle that compresses sensor data for sending to a second vehicle, and the decoder of the architecture may be implemented by the processing system of the second vehicle that receives the compressed sensor data from the first vehicle.

As shown in FIG. 4, encoder-decoder architecture 400 may include splitter 404, encoder 408, combiner 412, and decoder 416. Encoder 408 and decoder 416 may be the respective encoder and decoder portions of an autoencoder that compresses and decompresses sensor data 402. While a single pair of encoder 408 and decoder 416 is illustrate in FIG. 4, encoder-decoder architecture 400 may include any number of pairs of encoders and decoders. In some examples, encoder 408 and decoder 416 may perform online machine learning, such as self-supervised learning, to improve the performance of encoder 408 and decoder 416, and to adaptively adjust the assignment of priority levels to features and the amount of compression applied to sensor data associated with features of different priority levels in ways that minimize the size of the compressed sensor data while preserving important details in the sensor data.

Splitter 404 may receive sensor data 402 that capture at least a portion of an environment around an ego vehicle, and may perform segmentation of sensor data 402 according to the techniques of this disclosure to generate sensor data portions 306A-306Q (collectively “sensor data portions 406”), each of which includes sensor data for an associated region of the environment.

Encoder 408 may compress each of sensor data portions 406 to generate compressed sensor data portions 410A-410Q (collectively “compressed sensor data portions 410”), according to the techniques of this disclosure. Given each of sensor data portions 406 represented as x=R^{m}, where x is the input space and m is the dimension of the input space, encoder 408 may encode the corresponding compressed sensor data portion as z=Rⁿ, where z is encoded space and n is the dimension of the encoded space.

Encoder 408 may, for a sensor data portion, determine the dimension n of the encoded space of the compressed sensor data portion based on the priority level of the region associated with the sensor data portion. That is, encoder 408 may determine the amount of compression to apply to a sensor data portion for a region of the environment based on the priority level of the region, as described in this disclosure, where the dimension n may be larger for sensor data portions for regions having higher priority levels, and the dimension n may be smaller for sensor data portions for regions having lower priority levels.

Combiner 412 may combine compressed sensor data portions 410 to generate compressed sensor data 414. That is, given that each compressed sensor data portion is associated with a portion of an environment captured by sensor data 402, combiner 412 may combine compressed sensor data portions 410 to generate compressed sensor data 414 that is the entirety of the environment captured by sensor data 402.

Decoder 416 may decompress compressed sensor data 414 to generate reconstructed sensor data 418. In some examples, an ADAS, such as of vehicle 302, may use reconstructed sensor data 418 to perform perception, prediction, and decision-making tasks for the purposes of autonomous driving or assisting the driver of vehicle 302. For example, the ADAS may proactively change the speed at which the vehicle is traveling, switch the vehicle to a different lane, change the route being driven, and the like to reduce the likelihood of certain objects and/or portions or the road being occluded from the field of view of the vehicle's sensors.

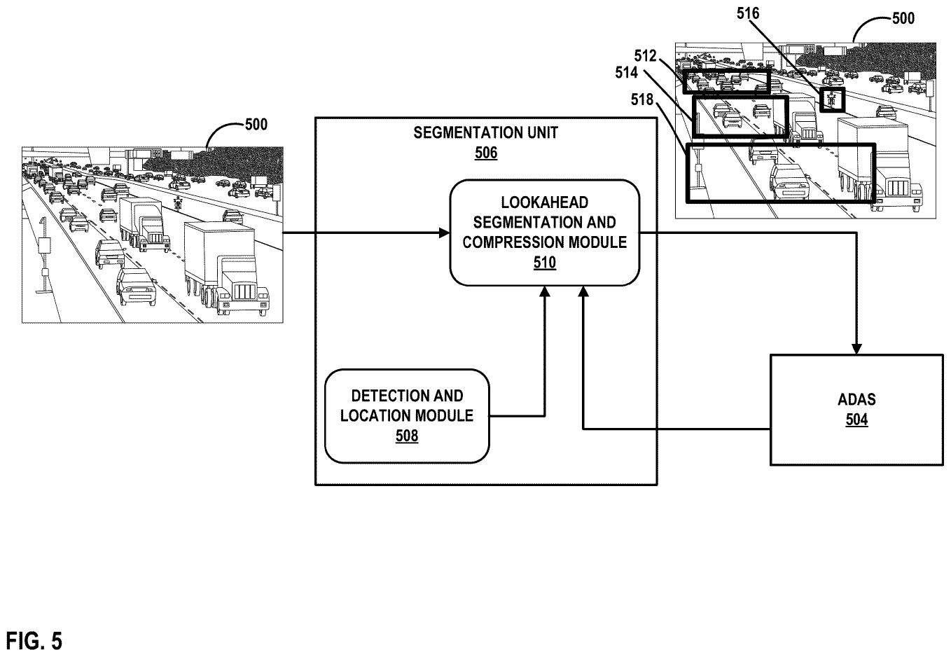

FIG. 5 is a block diagram illustrating an example segmentation unit and an example advanced driver assistance system (ADAS) for segmenting and compressing sensor data, in accordance with one or more techniques of this disclosure. Segmentation unit 506 is an example of segmentation unit 206 shown in FIG. 2, and ADAS 504 is an example of ADAS 204 shown in FIG. 2.

As shown in FIG. 5, segmentation unit 506 may include detection and location module 508 and lookahead segmentation and compression module 510. Segmentation unit 506 may receive sensor data generated by one or more sensors of a vehicle (e.g., vehicle 102 of FIG. 1) that captures environment 500 surrounding the vehicle. Detection and location module 508 may detect, based on the sensor data, objects in environment 500, such as vehicles (e.g., cars, large trucks, etc.), and may determine the locations of the detected objects in environment 500, such as the locations of the detected objects in relation to the vehicle, and may send information regarding the detected objects and the locations of the detected objects to lookahead segmentation and compression module 510.

Lookahead segmentation and compression module 510 may, based on the sensor data that captures environment 500 and the information regarding the detected objects and the locations of the detected objects in environment 500 received from detection and location module 508, perform segmentation and compression of the sensor data that captures environment 500.

Lookahead segmentation and compression module 510 may identify, based on the sensor data and the information received from detection and location module 508, features in the environment 500, such as vehicles, road signs, and the like. The features in the environment 500 may also include portions of roads in the environment 500, road conditions of the portions of the road, and the like. Lookahead segmentation and compression module 510 may determine, based on the sensor data and the information received from detection and location module 508, attributes of the identified features in the environment. 500 Example attributes of a feature may include the type of the feature, the location of the feature, and the like. In examples where the identified feature is a vehicle, example attributes of the vehicle may include the type of the vehicle, the speed of the vehicle, the size of the vehicle, whether or not the vehicle is traveling in a pack with other vehicles, the driving style of the vehicle, whether the vehicle is accelerating or decelerating, the stopping distance of the vehicle, the direction and orientation of the vehicle, lane information of the vehicle

Lookahead segmentation and compression module 510 may determine priority levels of the identified features in the environment 500 based on the determined attributes of the features. Lookahead segmentation and compression module 510 may determine a priority level of a feature based on a likelihood of the feature interfering with vehicle 102 in the near future, such as a likelihood of the feature potentially occluding a portion of the environment from the field of view of the sensors of vehicle 102 in the near future or a likelihood of the feature potentially causing a hazard scenario for vehicle 102.

Lookahead segmentation and compression module 510 may segment the sensor data into a plurality of portions of the sensor data associated with corresponding regions of the environment 500 based on the priority levels of the features in the regions of the environment 500. Lookahead segmentation and compression module 510 may determine, in the environment 500, regions of interest associated with the identified features, where each region of interest in the environment includes at least a portion of the associated feature. For example, lookahead segmentation and compression module 510 may, for an identified feature in the environment, determine a region of interest in the environment that includes at least a portion of the identified feature, and may determine the size and/or position of the region of interest in the environment. Lookahead segmentation and compression module 510 may determine, for each of the regions of interest, a priority level that corresponds to the priority level of the feature. For example, lookahead segmentation and compression module 510 may segment environment 500 by determining regions 512, 514, 516, and 518 that include portions of identified features in environment 500.

Lookahead segmentation and compression module 510 may adaptively compress the portions of the sensor data based on compression levels for compressing the plurality of portions of the sensor data inversely correlate to the priority levels of the regions of interest in the environment. That is, lookahead segmentation and compression module 510 may apply a relatively low amount of compression (or no compression) to sensor data associated with regions of a high priority level, and may apply a relatively high amount of compression to sensor data associated with regions of a low priority level.

Lookahead segmentation and compression module 510 may send the compressed sensor data to ADAS 504. ADAS 504 may control, based on the compressed sensor data, a vehicle such as vehicle 102. ADAS 504 may decompress the compressed sensor data to generate reconstructed sensor data that ADAS 504 may use to control vehicle 102 to perform perception, prediction, and decision-making tasks for the purposes of autonomous driving or assisting the driver of vehicle 102.

In some examples, ADAS 504 may, based on the compressed sensor data received from lookahead segmentation and compression module 510, provide feedback to lookahead segmentation and compression module 510 regarding the prioritization of features and the segmentation and compression of sensor data. Lookahead segmentation and compression module 510 may use such feedback from ADAS 504 to adjust the prioritization of features, the segmentation of the sensor data, and/or the compression levels of sensor data.

ADAS 504 may receive, from lookahead segmentation and compression module 510, as part of or in addition to the compressed sensor data, information regarding locations of other vehicles on the road with respect to the location of vehicle 102 in environment 500, and may determine possible hazard scenarios that may involve other vehicles on the road in environment 500. Such hazard scenarios may be situations or sequences of events in which the operation of vehicle 102 may encounter potential risks or threats to safety, or in which the other vehicles may occlude portions of the environment from the field of view of vehicle 102 sensors.

ADAS 504 may communicate the likelihood of the vehicles on the road being involved in potential hazard scenarios to lookahead segmentation and compression module 510, and lookahead segmentation and compression module 510 may adjust the priority levels of the vehicles based on the likelihood of the vehicles being involved in potential hazard scenarios. For example, if ADAS 504 communicates that a vehicle in environment 500 is highly likely to be involved in a potential hazard scenario, lookahead segmentation and compression module 510 may increase the priority level of the vehicle, which may cause lookahead segmentation and compression module 510 to segment the sensor data to determine a region of interest that includes the vehicle and/or cause lookahead segmentation and compression module 510 to decrease the amount of compression that is applied to a region of interest that includes the vehicle. Similarly, if ADAS 504 communicates that a vehicle in environment 500 is not likely to be involved in a potential hazard scenario, ADAS 504 may decrease the priority level of the vehicle, which may lead to lookahead segmentation and compression module 510 to refrain from determining a region of interest that includes the vehicle and/or cause environment 500 to increase the amount of compression that is applied to a region of interest that includes the vehicle.

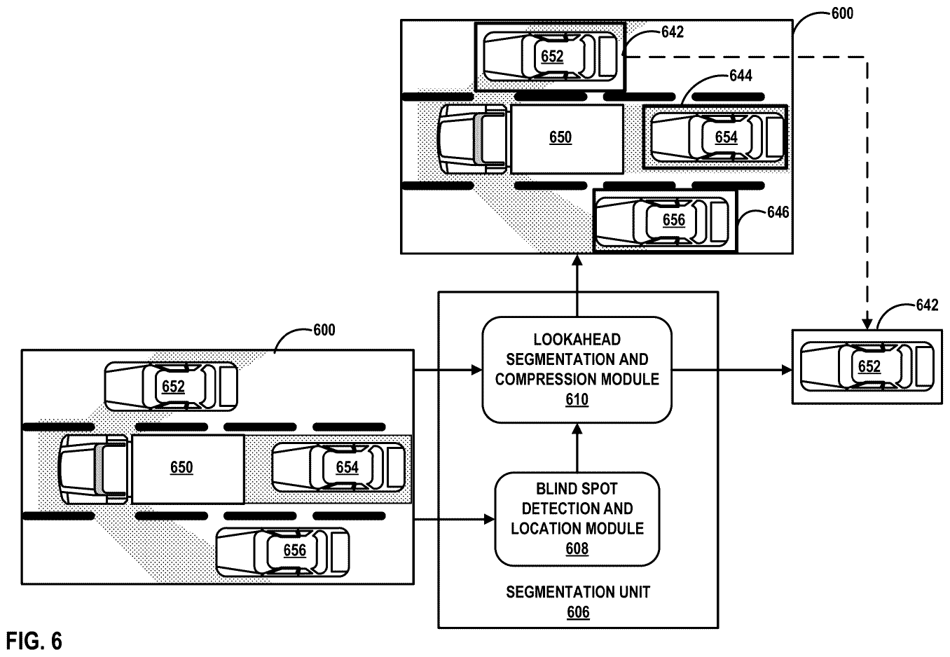

FIG. 6 is a block diagram illustrating an example segmentation unit that broadcasts segmented sensor data to nearby vehicles, in accordance with one or more techniques of this disclosure. Segmentation unit 606 is an example of segmentation unit 206 shown in FIG. 2.

As shown in FIG. 6, segmentation unit 606 includes blind spot detection and location module 608 and lookahead segmentation and compression module 610. In some examples, lookahead segmentation and compression module 610 is an example of lookahead segmentation and compression module 510 shown in FIG. 5.

Segmentation unit 606 may receive sensor data generated by one or more sensors of a vehicle (e.g., vehicle 102 of FIG. 1) that captures environment 600 surrounding the vehicle. As can be seen, environment 600 includes ego vehicle 650, which is a large truck, as well as vehicles 652, 654, and 656 that are proximate to the vehicle. Blind spot detection and location module 608 may, based on the sensor data, detect vehicles 652, 654, and 656 that are proximate to ego vehicle 650 and determine the locations of vehicles 652, 654, and 656 with respect to ego vehicle 650. Blind spot detection and location module 608 may send information regarding vehicles 652, 654, and 656 that are proximate to ego vehicle 650, including the locations of vehicles 652, 654, and 656 with respect to ego vehicle 650, to lookahead segmentation and compression module 610.

Lookahead segmentation and compression module 610 may receive the sensor data that captures environment 600 and may also receive, from location module 608, information regarding vehicles 652, 654, and 656 that are proximate to ego vehicle 650. Lookahead segmentation and compression module 610 may segment and compress the sensor data according to the techniques of this disclosure, such as described with respect to segmentation unit 206 and lookahead segmentation and compression module 510, to segment the sensor data into a plurality of regions, such as regions 642, 644, and 646 in environment 600, and to compress the regions of the sensor data.

In some examples, lookahead segmentation and compression module 610 may share, with other vehicles (e.g., wirelessly broadcast to other vehicles), sensor data associated with regions (e.g., blind spots) that the ego vehicle 650 may be occluding from the other vehicles. Lookahead segmentation and compression module 610 may determine, based on the locations of other proximate vehicles, regions of the environment 500 that are potentially occluded from the other vehicles by the ego vehicle 650. As can be seen in FIG. 6, ego vehicle 650 may be occluding region 642 containing vehicle 652 from vehicles 654 and 656.

Lookahead segmentation and compression module 610 may therefore determine that region 642 containing vehicle 652 is occluded from vehicles 654 and 656, and may wirelessly broadcast, to vehicles proximate to ego vehicle 650, such as vehicles 654 and 656, sensor data for region 642 containing vehicle 652. In some examples, lookahead segmentation and compression module 610 may broadcast the sensor data in compressed form, according to the techniques of this disclosure.

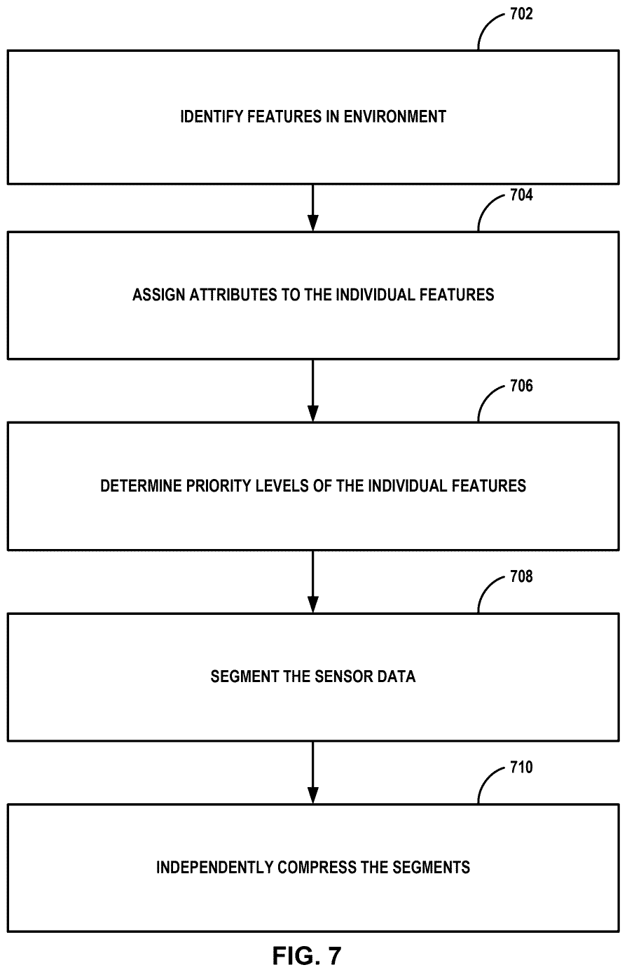

FIG. 7 is a flowchart showing an example method for segmenting and compressing sensor data, according to the techniques of this disclosure. FIG. 7 is described with respect to vehicle 102 of FIG. 1 and computing system 200 of FIG. 2.

As shown in FIG. 7, segmentation unit 206 may identify individual features in an environment surrounding an ego vehicle based on sensor data that captures the environment (702). Segmentation unit 206 may receive sensor data from one or more sensors of vehicle 102 that captures an environment around vehicle 102 during operation of vehicle 102, such as when vehicle 102 is being driven on a road. The environment around vehicle 102 may include features such as the road lanes, road boundaries, objects (e.g., vehicles), road signs, and the like surrounding the vehicle that are within the field of view of the one or more sensors of vehicle 102.

Segmentation unit 206 may identify, based on the sensor data, features in the environment. The features in the environment may include one or more objects, such as other vehicles (e.g., vehicles other than vehicle 102), road signs, and the like. The features in the environment may also include portions of roads in the environment, road conditions of the portions of the road, and the like. Segmentation unit 206 may identify vehicles, road signs, road conditions, or other features in the environment using any suitable technique, such as one or more neural networks trained via machine learning to identify certain features in an environment.

Segmentation unit 206 may assign attributes to the individual features in the environment (704). Segmentation unit 206 may determine attributes of the identified features in the environment and, for each individual feature, assign, to the individual feature, the determined attributes of the individual feature. Example attributes of a feature may include the type of the feature, the location of the feature, and the like. In examples where the identified feature is a vehicle, example attributes of the vehicle may include the type of the vehicle, the speed of the vehicle, the size of the vehicle, whether or not the vehicle is traveling in a pack with other vehicles, the driving style of the vehicle, whether the vehicle is accelerating or decelerating, the stopping distance of the vehicle, the direction and orientation of the vehicle, lane information of the vehicle. Segmentation unit 206 may determine the attributes of features in the environment using any suitable technique, such as one or more neural networks trained via machine learning to determine attributes of features in an environment.

Segmentation unit 206 may determine priority levels of the individual features in the environment based on the attributes assigned to the individual features (706). Segmentation unit 206 may determine a priority level of a feature based on a likelihood of the feature interfering with vehicle 102 in the near future, such as a likelihood of the feature potentially occluding a portion of the environment from the field of view of the sensors of vehicle 102 in the near future or a likelihood of the feature potentially causing a hazard scenario for vehicle 102. A higher priority level may denote a higher likelihood of the feature interfering with vehicle 102 in the near future, while a lower priority level may denote a lower likelihood of the feature interfering with vehicle 102 in the near future. In this way, segmentation unit 206 may assign, to each identified feature in the environment, a priority level out of a plurality of priority levels.

Segmentation unit 206 may segment the sensor data (708) into a plurality of segments. In the example of images captured by, e.g., cameras 130, 132, and/or 134 of vehicle 102, segmentation unit 206 may segment an image into a plurality of regions, which may include one or more regions of interest. In the example of 3D point clouds captured by, e.g., LiDAR sensor 135, segmentation unit 206 may segment 3D point clouds into a plurality of portions, each representing a corresponding region in the environment.

Segmentation unit 206 may segment the sensor data into a plurality of portions of the sensor data associated with corresponding regions of the environment based on the priority levels of the external objects in the regions of the environment. Segmentation unit 206 may determine, in the environment, regions of interest associated with the identified features, where each region of interest in the environment includes at least a portion of the associated feature. For example, segmentation unit 206 may, for an identified feature in the environment, determine a region of interest in the environment that includes at least a portion of the identified feature, and may determine the size and/or position of the region of interest in the environment. Segmentation unit 206 may determine, for each of the regions of interest, a priority level that corresponds to the priority level of the feature. For example, if a vehicle is identified to have a highest priority level out of a plurality of priority levels, segmentation unit 206 may determine that a region of interest that contains the vehicle may also have the highest priority level out of a plurality of priority levels.

Segmentation unit 206 may independently compress segments of the sensor data (710). As described above, each segment of the sensor data may be a portion of the sensor data that represents a region of the environment sensed by the sensor data, such as a region of an image that corresponds to a region of the environment, or a portion of sensor data that represents a corresponding region in the environment.

Segmentation unit 206 may adaptively compress each individual portion of the sensor data based on the priority level of the individual portion of the sensor data. Segmentation unit 206 may select, for an individual portion of sensor data, a compression level that inversely correlates with the priority level of the individual portion of sensor data. That is, segmentation unit 206 may apply a relatively low amount of compression (or no compression) to sensor data associated with regions of a high priority level, and may apply a relatively high amount of compression to sensor data associated with regions of a low priority level. Segmentation unit 206 may therefore store the compressed segments of the sensor data in memory 202 for use by, e.g., ADAS 204, or may wirelessly communicate one or more of the compressed segments of the sensor data to other vehicles in the environment.

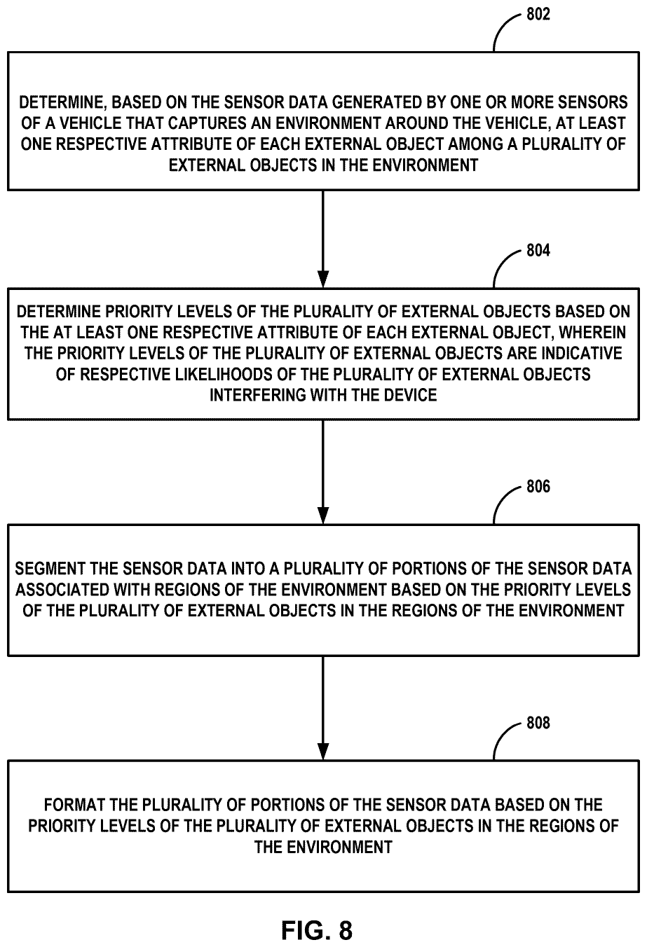

FIG. 8 is a flowchart showing an example method of operation according to the techniques of this disclosure. FIG. 8 is described with respect to vehicle 102 of FIG. 1 and computing system 200 of FIG. 2. However, the techniques of FIG. 8 may be performed by different components of computing system 200 or by additional or alternative systems, including systems of devices that are not vehicles. As shown in FIG. 8, processing circuitry 243 may determine, based on the sensor data generated by one or more sensors of a device that captures an environment around the device, at least one respective attribute of each external object among a plurality of external objects in the environment (802). In some examples, the at least one respective attribute of each external object include one or more of: a size of the external object, a location of the external object with respect to the device, a speed of travel of the external object, driving behavior of the external object, or a road condition in the environment. In some examples, the device may be a vehicle, an extended reality device (e.g., an augmented reality device, a virtual reality device, a mixed reality device, etc.), a robotic device, or any other suitable device.

Processing circuitry 243 may determine priority levels of the plurality of external objects based on the at least one respective attributes of each external object, wherein the priority levels of the plurality of external objects are indicative of respective likelihoods of the plurality of external objects interfering with the device (804). In some examples, the respective likelihoods of the plurality of external objects interfering with the device are respective likelihoods of the plurality of external objects occluding an area of the environment from the one or more sensors.

Processing circuitry 243 may segment the sensor data into a plurality of portions of the sensor data associated with regions of the environment based on the priority levels of the plurality of external objects in the regions of the environment (806). In some examples, to segment the sensor data into the plurality of portions of the sensor data, the processing circuitry 243 may determine regions of interest in the environment associated with the external object and determine, for each region of interest of the regions of interest, a priority level for the region of interest that corresponds to a priority level of an external object in the region of interest.

Processing circuitry 243 may format the plurality of portions of the sensor data based on the priority levels of the plurality of external objects in the regions of the environment (808). In some examples, to adaptively format the plurality of portions of the sensor data, the processing circuitry 243 may adaptively compress the plurality of portions of the sensor data based on the priority levels of the regions of interest of the environment to generate compressed sensor data. In some examples, to format the plurality of portions of the sensor data, the processing circuitry 243 may adaptively compress the plurality of portions of the sensor data based on the priority levels of the regions of interest of the environment to generate compressed sensor data. In some examples, the compression levels for compressing the plurality of portions of the sensor data inversely correlate to the priority levels of the regions of interest in the environment. In some examples, to adaptively compress the plurality of portions of the sensor data based on the priority levels of the regions of interest of the environment to generate compressed sensor data, processing circuitry 243 may use an autoencoder to adaptively compress the plurality of portions of the sensor data based on the priority levels of the regions of interest of the environment to generate compressed sensor data.

In some examples, the processing circuitry 243 may update a priority level of an external object, in response to receiving updated sensor data generated by the one or more sensors, determine a portion of the updated sensor data for a region in the environment associated with the external object, and compress the portion of the updated sensor data according to the updated priority level of the external object.

In some examples, to adaptively compress the plurality of portions of the sensor data, the processing circuitry 243 may determine that a first portion of the sensor data is associated with a first region of interest having a highest priority level out of the priority levels. Processing circuitry 243 may, based on the first portion of the sensor data being associated with the first region of interest having the highest priority level, refrain from compressing the first portion of the sensor data.

In some examples, processing circuitry 243 may decompress the compressed sensor data to generate reconstructed sensor data, and may control the vehicle using the reconstructed sensor data.

In some examples, the processing circuitry 243 and the memory 202 are part of an advanced driver assistance system (ADAS) 204.

In some examples, the processing circuitry 243 may broadcast one or more of the plurality of portions of the sensor data to one or more external objects. In some examples, to broadcast the one or more of the plurality of portions of the sensor data to the one or more external objects, the processing circuitry 243 may determine a location of an external object, determine, based on the location of the external object, a region of the environment that is occluded by the vehicle from the external object, and send, to the external object, a portion of the sensor data that captures features in the region of the environment to the external object.

Additional aspects of the disclosure are detailed in numbered clauses below.

Clause 1. A computing system of a device for processing sensor data, comprising: a memory; and processing circuitry in communication with the memory, wherein the processing circuitry is configured to: determine, based on sensor data generated by one or more sensors of a device that captures an environment around the device, at least one respective attribute of each external object among a plurality of external objects in the environment; determine priority levels of the plurality of external objects based on the at least one respective attribute of each external object, wherein the priority levels of the plurality of external objects are indicative of respective likelihoods of the plurality of external objects interfering with the device; segment the sensor data into a plurality of portions of the sensor data associated with regions of the environment based on the priority levels of the plurality of external objects in the regions of the environment; and format the plurality of portions of the sensor data based on the priority levels of the plurality of external objects in the regions of the environment.

Clause 2. The computing system of clause 1, wherein to segment the sensor data into the plurality of portions of the sensor data, the processing circuitry is further configured to: determine regions of interest in the environment associated with the plurality of external objects; and determine, for each region of interest of the regions of interest, a priority level for the region of interest that corresponds to a priority level of an external object in the region of interest.

Clause 3. The computing system of clause 2, wherein to format the plurality of portions of the sensor data, the processing circuitry is further configured to: compress the plurality of portions of the sensor data based on the priority levels of the regions of interest of the environment to generate compressed sensor data.

Clause 4. The computing system of clause 3, wherein to compress the plurality of portions of the sensor data, the processing circuitry is further configured to: compress, using an autoencoder, the plurality of portions of the sensor data based on the priority levels of the regions of interest of the environment to generate compressed sensor data.

Clause 5. The computing system of any of clauses 3 and 4, wherein compression levels for compressing the plurality of portions of the sensor data inversely correlate to the priority levels of the regions of interest in the environment.

Clause 6. The computing system of clause 5, wherein the processing circuitry is further configured to: update a priority level of an external object; in response to receiving updated sensor data generated by the one or more sensors, determine a portion of the updated sensor data for a region in the environment associated with the external object; and compress the portion of the updated sensor data according to the updated priority level of the external object.

Clause 7. The computing system of any of clauses 5 and 6, wherein to compress the plurality of portions of the sensor data, the processing circuitry is further configured to: determine that a first portion of the sensor data is associated with a first region of interest having a highest priority level out of the priority levels; and based on the first portion of the sensor data being associated with the first region of interest having the highest priority level, refrain from compressing the first portion of the sensor data.

Clause 8. The computing system of any of clauses 3-7, wherein the processing circuitry is further configured to: decompress the compressed sensor data to generate reconstructed sensor data; and control the device using the reconstructed sensor data.

Clause 9. The computing system of any of clauses 1-8, wherein the at least one respective attribute of each external object include one or more of: a size of the external object, a location of the external object with respect to the device, a speed of travel of the external object, driving behavior of the external object, or a road condition in the environment.

Clause 10. The computing system of any of clauses 1-9, wherein the respective likelihoods of the plurality of external objects interfering with the device are the respective likelihoods of the plurality of external objects occluding an area of the environment from the one or more sensors.

Clause 11. The computing system of any of clauses 1-10, wherein the processing circuitry is further configured to: transmit one or more of the plurality of portions of the sensor data to one or more nearby external objects.

Clause 12. The computing system of clause 11, wherein to transmit the one or more of the plurality of portions of the sensor data to the one or more nearby external objects, the processing circuitry is further configured to: determine a location of an external object; determine, based on the location of the external object, a region of the environment that is occluded by the device from the external object; and send, to the external object, a portion of the sensor data that captures features in the region of the environment to the external object.

Clause 13. The computing system of any of clauses 1-12, wherein the processing circuitry and the memory are part of an advanced driver assistance system (ADAS).

Clause 14. The computing system of any of clauses 1-13, wherein the one or more sensors include one or more of: one or more cameras configured to capture a set of 2D camera images or a Light Detection and Ranging (LiDAR) system configured to capture a set of 3D point cloud frames.

Clause 15. A method comprising: determining, based on sensor data generated by one or more sensors of a device that captures an environment around the device, at least one respective attribute of each external object among a plurality of external objects in the environment; determining priority levels of the plurality of external objects based on the at least one respective attribute of each external object, wherein the priority levels of the plurality of external objects are indicative of respective likelihoods of the plurality of external objects interfering with the device; segmenting the sensor data into a plurality of portions of the sensor data associated with regions of the environment based on the priority levels of the plurality of external objects in the regions of the environment; and formatting the plurality of portions of the sensor data based on the priority levels of the plurality of external objects in the regions of the environment.

Clause 16. The method of clause 15, wherein segmenting the sensor data into the plurality of portions of the sensor data further comprises: determining regions of interest in the environment associated with the plurality of external objects; and determining, for each region of interest of the regions of interest, a priority level for the region of interest that corresponds to a priority level of an external object in the region of interest.

Clause 17. The method of clause 16, wherein formatting the plurality of portions of the sensor data further comprises: compressing the plurality of portions of the sensor data based on the priority levels of the regions of interest of the environment to generate compressed sensor data.

Clause 18. The method of clause 17, wherein compression levels for compressing the plurality of portions of the sensor data inversely correlate to the priority levels of the regions of interest in the environment.

Clause 19. The method of clause 18, further comprising: updating a priority level of an external object; in response to receiving updated sensor data generated by the one or more sensors, determining a portion of the updated sensor data for a region in the environment associated with the external object; and compressing the portion of the updated sensor data according to the updated priority level of the external object.

Clause 20. A computer-readable medium storing instructions that, when applied by processing circuitry, causes the processing circuitry to: determine, based on sensor data generated by one or more sensors of a device that captures an environment around the device, at least one respective attribute of each external object among a plurality of external objects in the environment; determine priority levels of the plurality of external objects based on the at least one respective attribute of each external object, wherein the priority levels of the plurality of external objects are indicative of respective likelihoods of the plurality of external objects interfering with the device; segment the sensor data into a plurality of portions of the sensor data associated with regions of the environment based on the priority levels of the plurality of external objects in the regions of the environment; and format the plurality of portions of the sensor data based on the priority levels of the plurality of external objects in the regions of the environment.

Clause 21. The computing system of any of clauses 1-14, wherein the device is a vehicle.

Clause 22. The computing system of any of clauses 1-14, wherein the device is an extended reality device.

Clause 23. The computing system of any of clauses 1-14, wherein the device is a robotic device.

Clause 24. The computing system of any of clauses 21-23, wherein the processing circuitry is further configured to output an indication of an external object from the plurality of external objects having a highest probability of colliding with the device.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and applied by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be applied by one or more processors, such as one or more DSPs, general purpose microprocessors, ASICs, FPGAs, or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A computing system of a device for processing sensor data, comprising:
a memory; and
processing circuitry in communication with the memory, wherein the processing circuitry is configured to:
determine, based on sensor data generated by one or more sensors of a device that captures an environment around the device, at least one respective attribute of each external object among a plurality of external objects in the environment;
determine priority levels of the plurality of external objects based on the at least one respective attribute of each external object, wherein the priority levels of the plurality of external objects are indicative of respective likelihoods of the plurality of external objects interfering with the device;
segment the sensor data into a plurality of portions of the sensor data associated with regions of the environment based on the priority levels of the plurality of external objects in the regions of the environment; and
format the plurality of portions of the sensor data based on the priority levels of the plurality of external objects in the regions of the environment.

2. The computing system of claim 1, wherein to segment the sensor data into the plurality of portions of the sensor data, the processing circuitry is further configured to:
determine regions of interest in the environment associated with the plurality of external objects; and
determine, for each region of interest of the regions of interest, a priority level for the region of interest that corresponds to a priority level of an external object in the region of interest.

3. The computing system of claim 2, wherein to format the plurality of portions of the sensor data, the processing circuitry is further configured to:
compress the plurality of portions of the sensor data based on the priority levels of the regions of interest of the environment to generate compressed sensor data.

4. The computing system of claim 3, wherein to compress the plurality of portions of the sensor data, the processing circuitry is further configured to:
compress, using an autoencoder, the plurality of portions of the sensor data based on the priority levels of the regions of interest of the environment to generate compressed sensor data.

5. The computing system of claim 3, wherein compression levels for compressing the plurality of portions of the sensor data inversely correlate to the priority levels of the regions of interest in the environment.

6. The computing system of claim 5, wherein the processing circuitry is further configured to:
update a priority level of an external object;
in response to receiving updated sensor data generated by the one or more sensors, determine a portion of the updated sensor data for a region in the environment associated with the external object; and
compress the portion of the updated sensor data according to the updated priority level of the external object.

7. The computing system of claim 5, wherein to compress the plurality of portions of the sensor data, the processing circuitry is further configured to:
determine that a first portion of the sensor data is associated with a first region of interest having a highest priority level out of the priority levels; and
based on the first portion of the sensor data being associated with the first region of interest having the highest priority level, refrain from compressing the first portion of the sensor data.

8. The computing system of claim 3, wherein the processing circuitry is further configured to:
decompress the compressed sensor data to generate reconstructed sensor data; and
control the device using the reconstructed sensor data.

9. The computing system of claim 1, wherein the at least one respective attribute of each external object include one or more of: a size of the external object, a location of the external object with respect to the device, a speed of travel of the external object, driving behavior of the external object, or a road condition in the environment.

10. The computing system of claim 1, wherein the respective likelihoods of the plurality of external objects interfering with the device are the respective likelihoods of the plurality of external objects occluding an area of the environment from the one or more sensors.

11. The computing system of claim 1, wherein the processing circuitry is further configured to:
transmit one or more of the plurality of portions of the sensor data to one or more nearby external objects.

12. The computing system of claim 11, wherein to transmit the one or more of the plurality of portions of the sensor data to the one or more nearby external objects, the processing circuitry is further configured to:
determine a location of an external object;
determine, based on the location of the external object, a region of the environment that is occluded by the device from the external object; and
send, to the external object, a portion of the sensor data that captures features in the region of the environment to the external object.

13. The computing system of claim 1, wherein the processing circuitry and the memory are part of an advanced driver assistance system (ADAS).

14. The computing system of claim 1, wherein the one or more sensors include one or more of: one or more cameras configured to capture a set of 2D camera images or a Light Detection and Ranging (LiDAR) system configured to capture a set of 3D point cloud frames.

15. A method comprising:
determining, based on sensor data generated by one or more sensors of a device that captures an environment around the device, at least one respective attribute of each external object among a plurality of external objects in the environment;
determining priority levels of the plurality of external objects based on the at least one respective attribute of each external object, wherein the priority levels of the plurality of external objects are indicative of respective likelihoods of the plurality of external objects interfering with the device;
segmenting the sensor data into a plurality of portions of the sensor data associated with regions of the environment based on the priority levels of the plurality of external objects in the regions of the environment; and
formatting the plurality of portions of the sensor data based on the priority levels of the plurality of external objects in the regions of the environment.

16. The method of claim 15, wherein segmenting the sensor data into the plurality of portions of the sensor data further comprises:
determining regions of interest in the environment associated with the plurality of external objects; and
determining, for each region of interest of the regions of interest, a priority level for the region of interest that corresponds to a priority level of an external object in the region of interest.

17. The method of claim 16, wherein formatting the plurality of portions of the sensor data further comprises:
compressing the plurality of portions of the sensor data based on the priority levels of the regions of interest of the environment to generate compressed sensor data.

18. The method of claim 17, wherein compression levels for compressing the plurality of portions of the sensor data inversely correlate to the priority levels of the regions of interest in the environment.

19. The method of claim 18, further comprising:
updating a priority level of an external object;
in response to receiving updated sensor data generated by the one or more sensors, determining a portion of the updated sensor data for a region in the environment associated with the external object; and
compressing the portion of the updated sensor data according to the updated priority level of the external object.

20. A computer-readable medium storing instructions that, when applied by processing circuitry, causes the processing circuitry to:
determine, based on sensor data generated by one or more sensors of a device that captures an environment around the device, at least one respective attribute of each external object among a plurality of external objects in the environment;
determine priority levels of the plurality of external objects based on the at least one respective attribute of each external object, wherein the priority levels of the plurality of external objects are indicative of respective likelihoods of the plurality of external objects interfering with the device;
segment the sensor data into a plurality of portions of the sensor data associated with regions of the environment based on the priority levels of the plurality of external objects in the regions of the environment; and
format the plurality of portions of the sensor data based on the priority levels of the plurality of external objects in the regions of the environment.
